(19) United States
(12) Patent Application Publication
(10) Pub. No.: US 2004/0227449 A1
(43) Pub. Date: Nov. 18, 2004

(54) Psychophysical perception enhancement

(76) Inventors: Chaim Scheff, Jerusalem (IL); Amir Ben-Shalom, Modiin (IL); Shlomit Engel, Mevasseret Zion (IL); David Coates, Merely Winborne (GB)

Correspondence Address: JOHN ALEXANDER GALBREATH, 2516 CHESTNUT WOODS CT, REISTERSTOWN, MD, 21136, US

(21) Appl. No.: 10/439,869

(22) Filed: May 17, 2003

(51) Int. Cl. H01J 29/10

(52) U.S. Cl. 313/474

(57) ABSTRACT

A Psychophysical Perception Enhancement, for use in juxtaposition to a perceptible output spectrum, and the enhancement includes: (a) designating a target enhancement region in the spectrum and the region is defined as having at least one boundary; (b) proximate to one of the boundaries, defining a perceptible transition region; and (c) in the transition region, applying a filter having a spectral shape substantially inverse to normal perception for the transition region. The enhancement is preferably applicable to a visual or audio systems and can be embodied as a digital, analog, mechanical, passive, optical element.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### RELATED DISCLOSURE STATEMENT

The instant specification contains subject matter in common with Disclosure Document No. 510787 entitled “Psychophysical Perception Enhancement” submitted by Inventors Scheff, Ben-Shalom, Engel-Dvir, and Coates—and received at the United States Patent and Trademark Office on May 3, 2002; and hereby claims all benefits legally available from said Disclosure Document. In addition, the entire contents of the Disclosure Document is incorporated herein by reference. Furthermore, to the best of our knowledge, there has not been any prior publication of the Disclosure Document nor of the contents of the instant specification nor of any portions thereof—for which claims will hereinafter be made.

### FIELD OF THE INVENTION

The present invention generally relates to perception enhancement. More specifically, the present invention relates to selection of at least one frequency proximate filter region and to respective filter characteristics thereat.

### BACKGROUND OF THE INVENTION

Both analog and digital filters generally relate to blocking out specific frequency ranges or equivalently to amplifying specific frequency ranges. According to the well know methodologies, the filter or amplification region should be well defined; although in practice there is often some slight albeit undesired transition region. Examples, according to this typical method would include for vision using a UV filter to block out radiation above a predetermined ultraviolet frequency, or for hearing using a selective band pass filter front end to an amplifier.

Simultaneous to the well-known methods for designing analog (or digital) filters and amplifiers, physiologists have appreciated Difference-Of-Gaussian (DOG) functions (also called Mexican Hat functions) as the operative recursive program of the retina and visual cortex. Although it has been difficult to scale up the appreciation of this function to other perceptual modalities and, even more so, there have not been successful models in trying to scale it up to cognitive functions. Nevertheless, the important physiologically verified results of DOG functions have not influenced designers of analog or digital filters to any amended criteria in their art.

One can divide this description into classes of examples focused on each of the five senses; vision, hearing, taste, touch, smell. However, we will only provide examples from the fields hearing and vision, since the perceptible spectrum for these is easier to understand in the context of teaching an invention.

In audio, there exist many known filters and transforms. Mechanical designs, compliant with the concept arising from physiological DOGs, are apparently the result of aesthetic preferences and not according to any scientific criteria; for example U.S. Pat. No. 6,301,555, U.S. Pat. No. 6,285,767, U.S. Pat. No. 6,243,671. One example will suffice. In the history of western (European) musical instruments, there has been a continuous evolution away from simple linear tuning and towards a more complex tuning function. Accordingly, it is easily observed that the string bed of a modern piano is not based on a right triangle but on a polynomial—specifically, the shape of the concert grand piano. This shape has not been chosen because of a calculation convolving physiological DOGs with the human audio perception spectrum, nor has it been chosen because of the physical shape of the human cochlea. The piano shape has been chosen according to the accumulated subjective aesthetic preferences of piano designers. Were one to suggest that the current shape can be used to calculate the complex interaction between perfected mechanical instruments and quantifiable perception, then a clear refutation comes from the electronic music industry—where digital samples of great mechanical instruments has become the standard in preference to any predetermined mathematically computable audio convolution of attack, sustain, and decay functions. This is a case of a longstanding need that, for lack of a scientific solution, is operating with a subjective quasi-alchemical paradigm: a patchwork of best available any-things.

In visual, there also exist many known filters and transforms. One area where the selection of optical filters has not yielded the expected benefits is with liquid crystal displays; for example U.S. Pat. No. 5,121,030, U.S. Pat. No. 6,344,710, U.S. Pat. No. 5,834,122, U.S. Pat. No. 5,521,759. This is an unexpected conclusion, since the simple superposition of a color filter against an active element optical display surface, such as a liquid crystal display, should provide a calculated color result. While there may be many deviations from the theory in use in actual displays, there remains a long felt need in the art for an improved red color. Likewise, other spectrum specific perception improvements are also complex to achieve according to heretofore known methods.

Specifically, introduction of inert red pigment into the liquid crystal layer of a display element has not produced the level of redness that is familiar with other color related display technologies. Furthermore, use of external red filters has also not produced the hoped for outstanding results.

According, there is a specific need in the art for an enhancement whereby a better red color is perceived from a liquid crystal display. Furthermore, there is a general longstanding need for an integrated enhancement methodology whereby filters compliant with specifications of actual perception can be complementarily designed and thereafter embodied.

### BRIEF SUMMARY OF THE INVENTION

The presert invention generally relates filters compliant with specifications of actual perception. Specifically, the present invention relates to embodiments of A Psychophysical Perception Enhancement, for use in juxtaposition to a perceptible output spectrum, and the enhancement includes: (a) designating a target enhancement region in the spectrum and the region is defined as having at least one boundary; (b) proximate to one of the boundaries, defining a perceptible transition region; and (c) in the transition region, applying a filter having a spectral shape substantially inverse to normal perception for the transition region.

Simply stated, placing a filter that is shaped (in its filtering characteristics) substantially inverse to perception in the same region (of the perception spectrum) will result in an enhanced perception of regions of the spectrum that are proximate to the filter. For example, in vision where the spectrum is ROYGBIV, insertion of a filter over the YG (yellow green) range that is optically inverse to perception in that YG range will result in enhanced perception of both O (orange) and B (blue). A similar type phenomenon may be observed in the hearing spectrum. Presumably, these are the result of higher-level DOG operations in the cortex.

Embodiments of the present invention relate to designing the filter and to the filter, per se, since both represent improvements over the prior art.

The best enabling mode of the present invention relates to an improved red filter for use with front lit liquid crystal displays, wherein simple use of red pigment results is an unacceptable darkening of the red perceived, while introduction of an inverse orange filter results in an improved red perception. Details for this best enable embodiment are to be found appendix 1.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 shows a schematic view of the Psychophysical Perception Enhancement of the present invention;

FIG. 2 shows a schematic view of a filter embodiment according to the Psychophysical Perception Enhancement;

FIG. 3 shows a schematic view of a program storage device aspect of the Psychophysical Perception Enhancement; and

FIGS. 4-33 shows laboratory findings, both summary and data, substantially for a best enabled red cholesteric mixture—for use with a liquid crystal display, and the mixture is filter in accordance with the present invention.

### DETAILED DESCRIPTION OF THE INVENTION

Embodiments and aspects of the invention relate to various forms, specific to a single sensory modality; and in other multi-dimensional representations, to multi-modal sensory aspects.

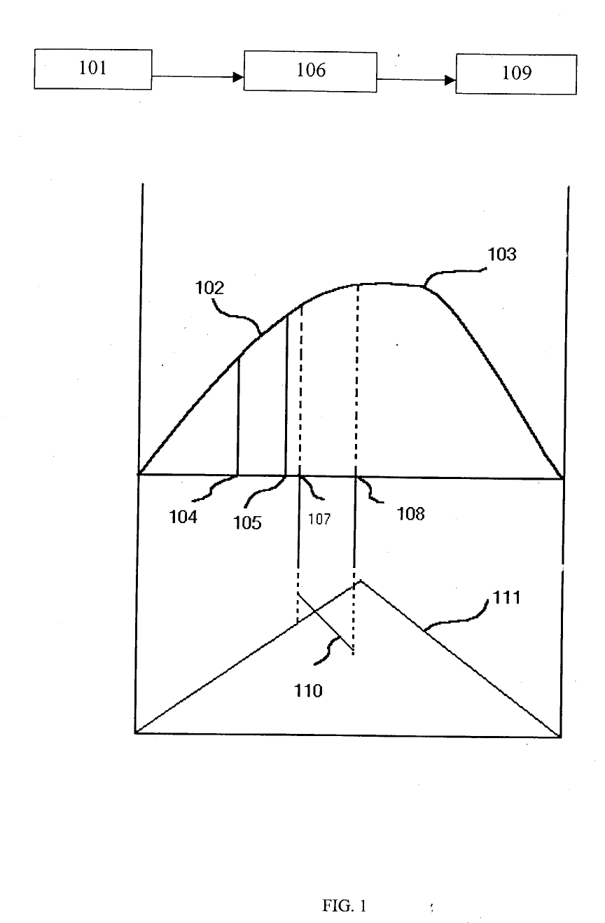

Turning to FIG. 1, the present invention relates to embodiments of A Psychophysical Perception Enhancement, for use in juxtaposition to a perceptible output spectrum, and the enhancement includes: (a) designating 101 a target enhancement region 102 in the spectrum 103 and the region is defined as having at least one boundary 104 105; (b) proximate to one of the boundaries, defining 106 a perceptible transition region 107 108; and (c) in the transition region, applying 109 a filter 110 having a spectral shape substantially inverse to normal perception 111 for the transition region.

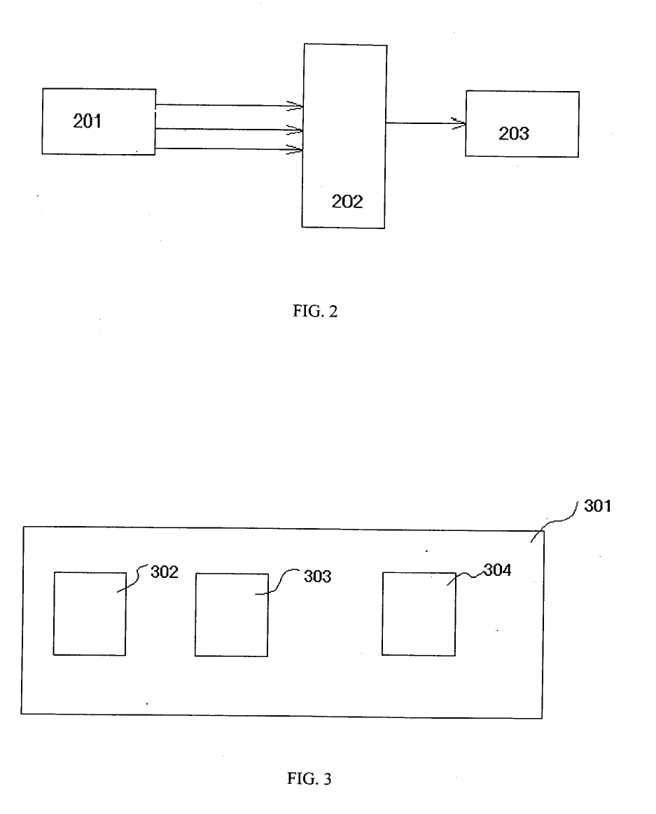

Turning to FIG. 2, a perceptible output spectrum 201 or a representation thereof traverses a bounded predetermined inverse spectral filter 202 (according to the Psychophysical Perception Enhancement of the present invention), for eventual perception by an observer 203 or for a memory media or for a signal carrier media that will eventually result in a perception by an observer.

In the context of the present invention, the perceptible output spectrum is a predetermined continuous region of the domain for a sensory modality. For example, in vision, the contiguous region might be the entire visible spectrum (ROYGBIV) or the contiguous might be just the RO (red through orange) portion therein. Likewise, in hearing, the contiguous region might be the entire range of normal cochlear audio perception or a portion therein.

Furthermore, in the context of the present invention, “a target enhancement region in the spectrum and the region is defined as having at least one boundary” is a continuous region, and the at least one boundary relates to an upper frequency value or a lower frequency value for the contiguous region. We use the general nomenclature of “having at least one boundary” to relate to the case of the boundary that is within the perceptible output spectrum, since the other boundary may be outside of that spectrum. Likewise, there are non-one dimensional representations of perception wherein the contiguous region may be defined as having more than two boundaries. Furthermore, “proximate to one of the boundaries” relates to one of the boundaries that is within the perceptible output spectrum. Therein, the transition region must have sufficient width, in the case of one dimensionally represented spectrum (and sufficient area, volume, etc. in the case of higher dimensional representations), to allow a filter having an inverse shape (in the same representation) to be differentiated from a standard band-pass type filter; which in all practical embodiments is not an infinitesimally narrow precise reversal from 0% to 100%.

According to a first class of embodiments of A Psychophysical Perception Enhancement wherein the target enhancement region is on a visual perception spectrum.

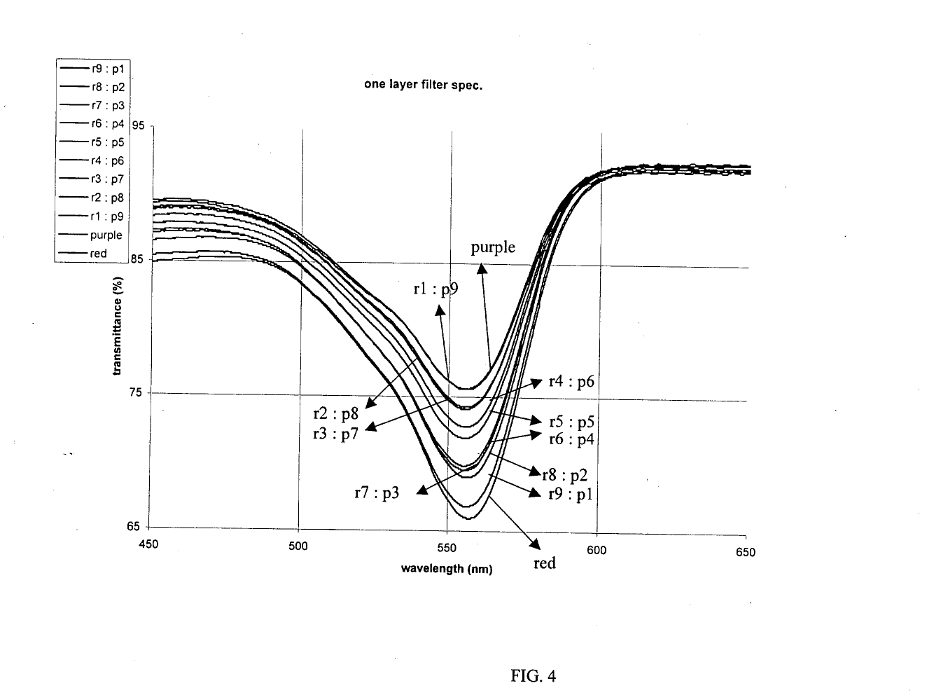

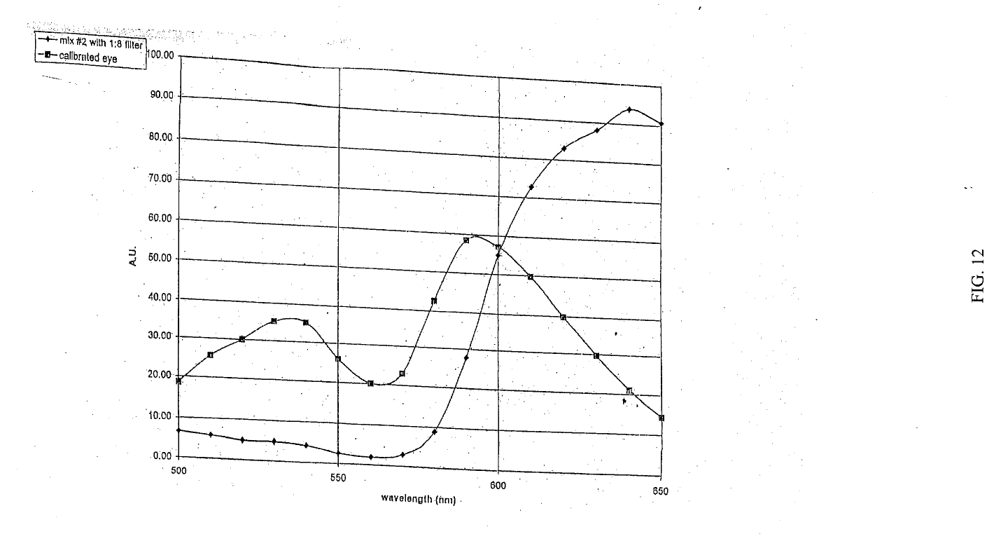

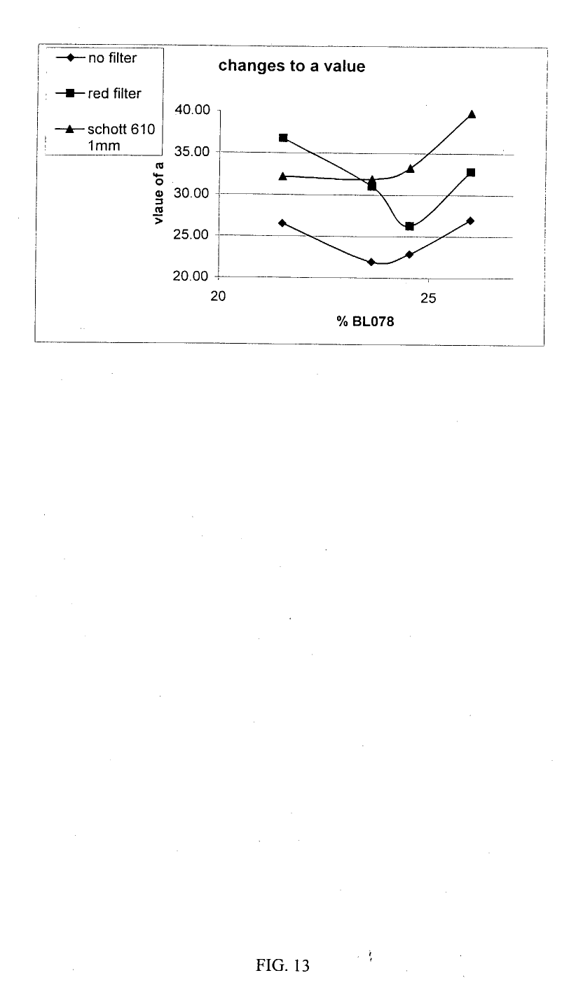

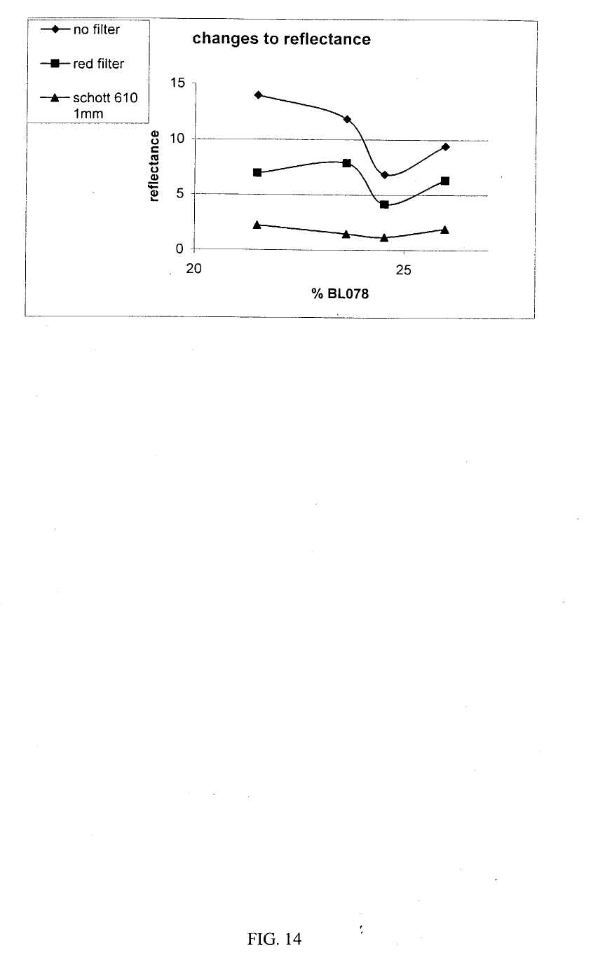

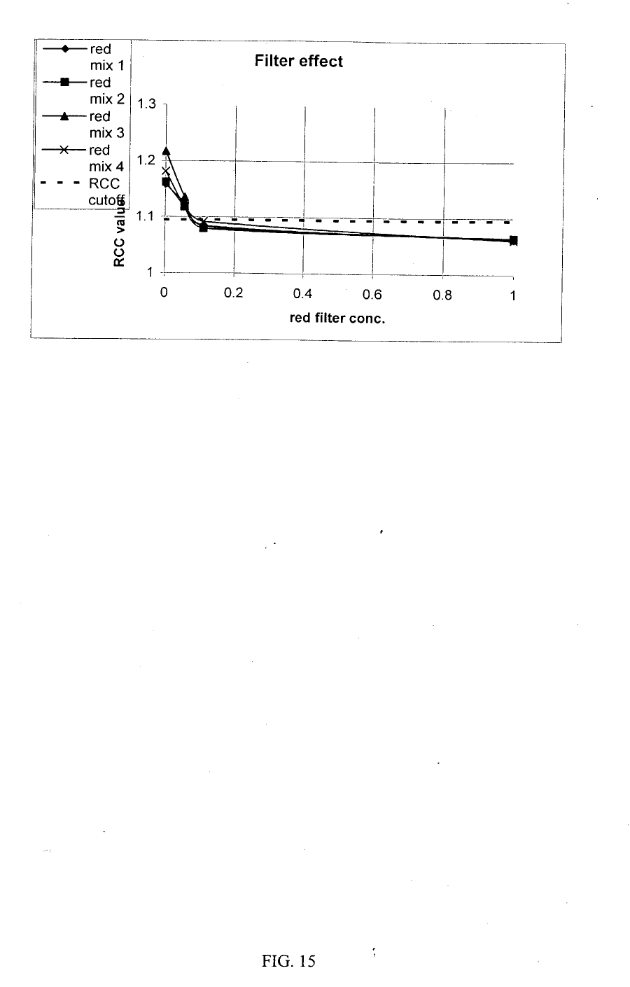

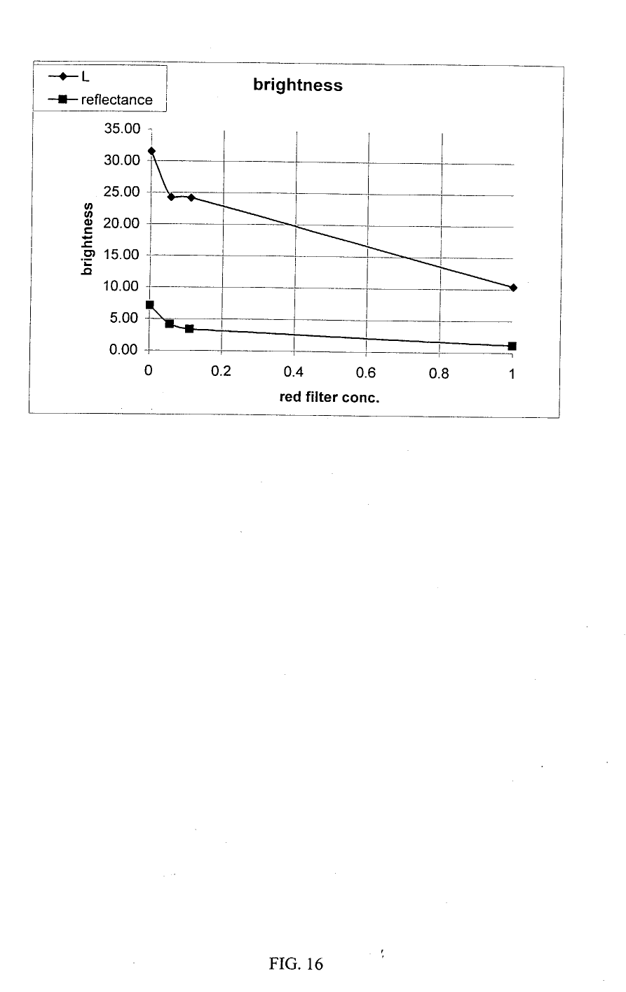

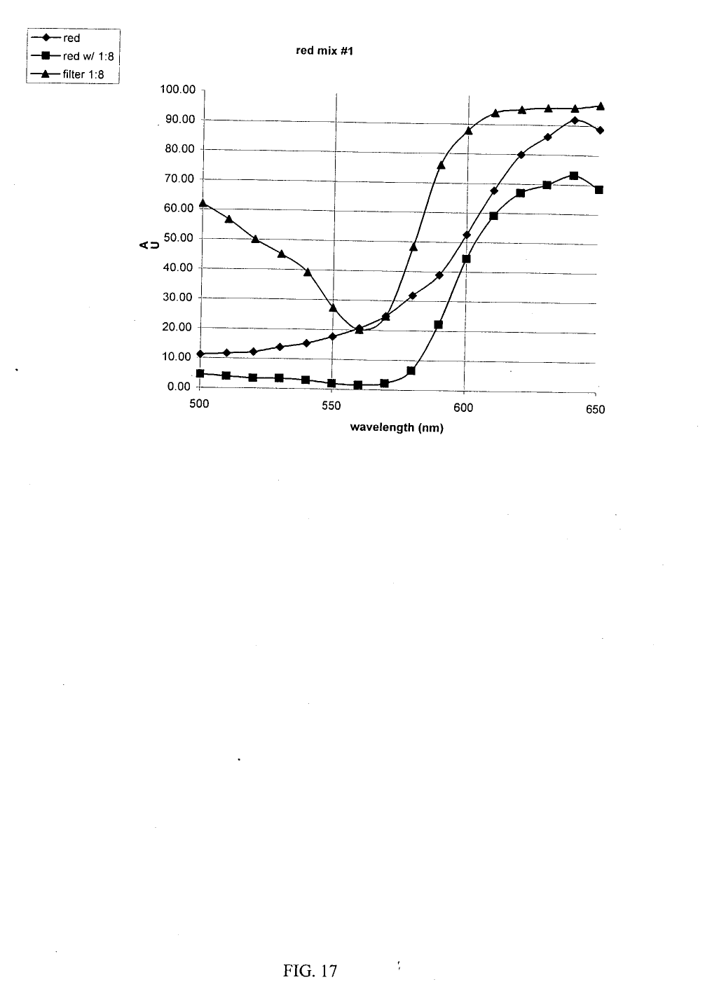

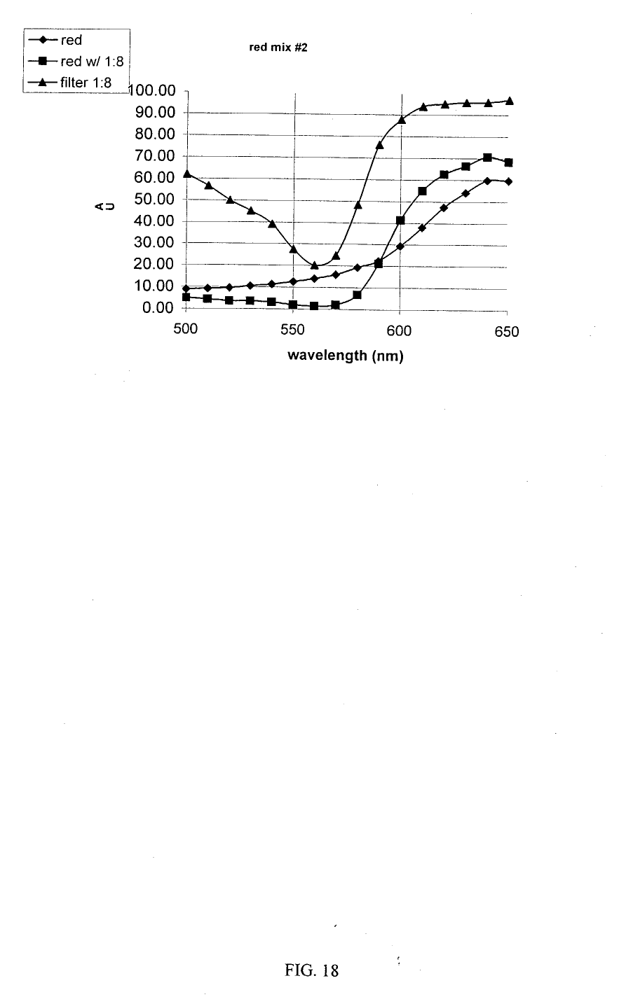

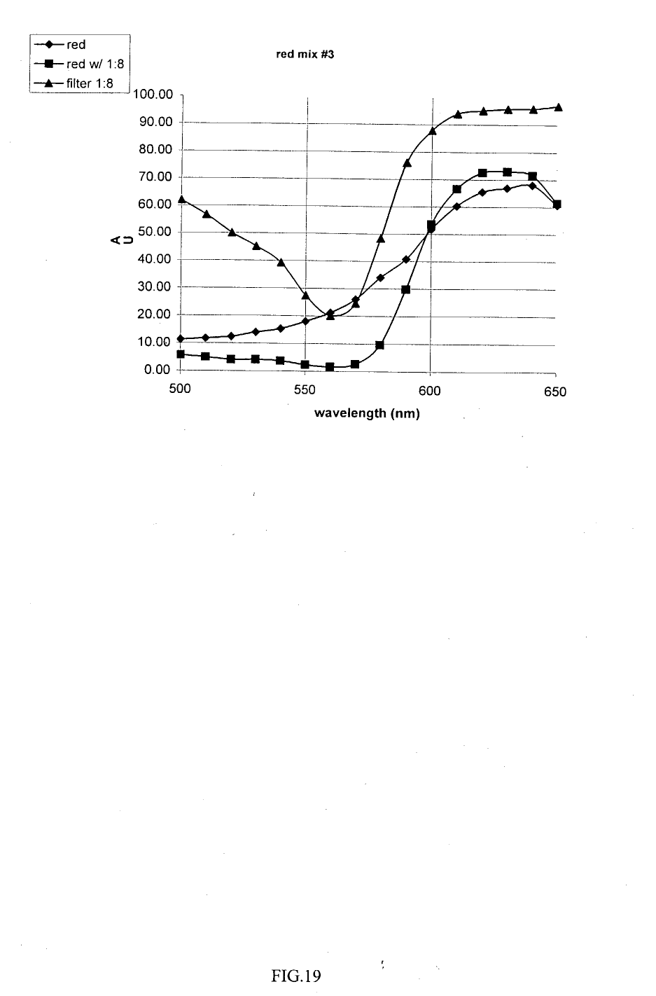

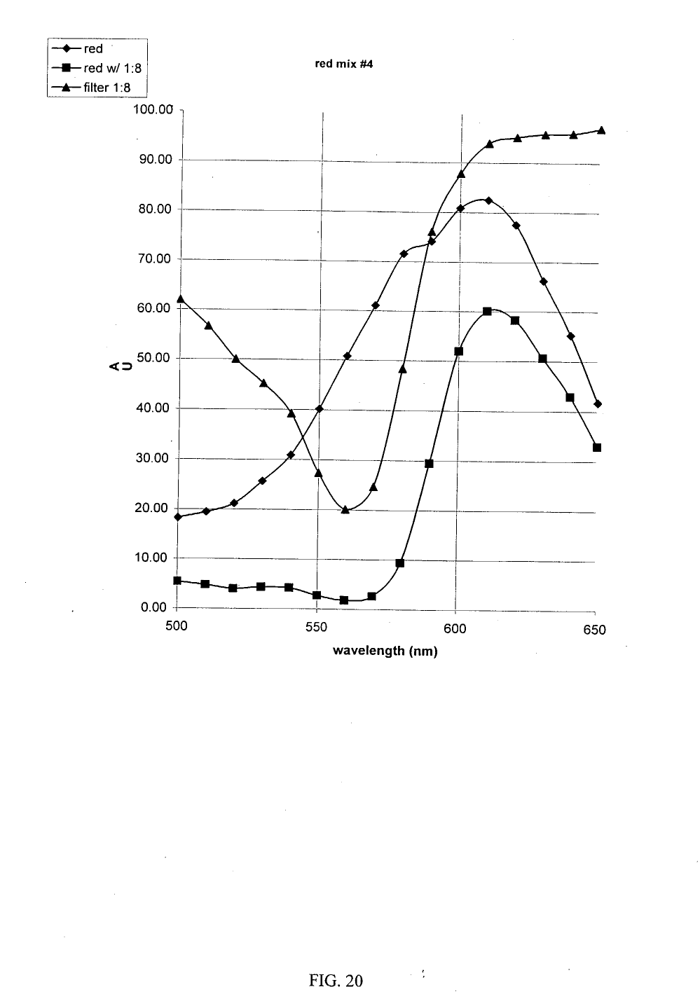

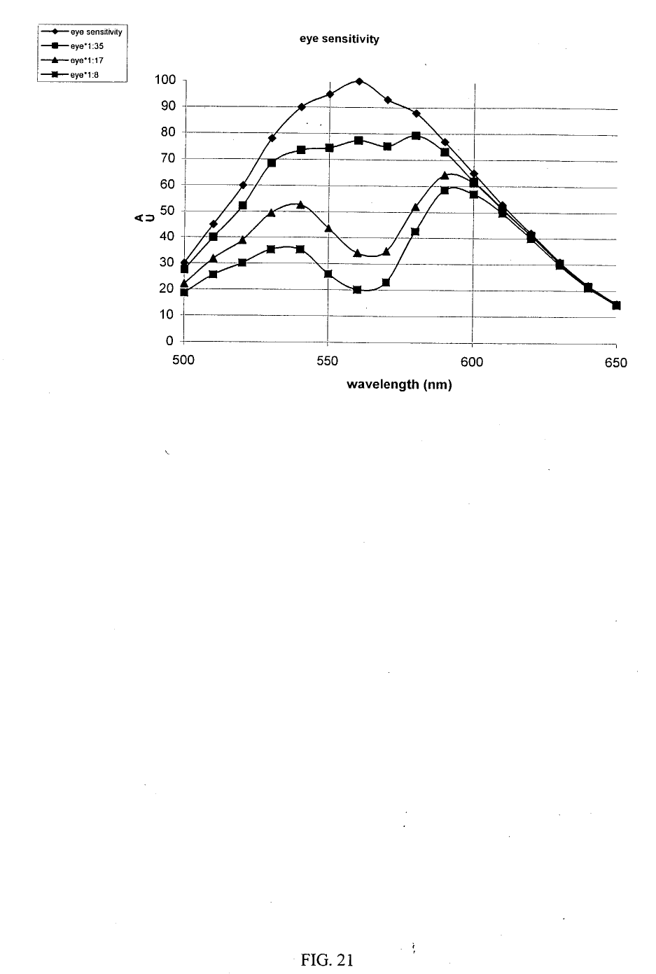

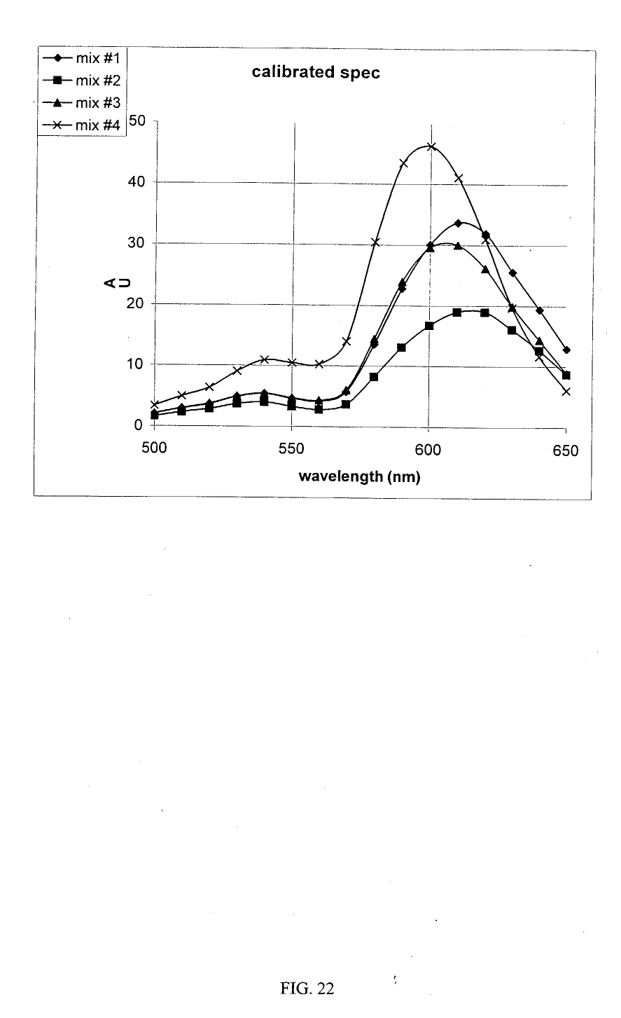

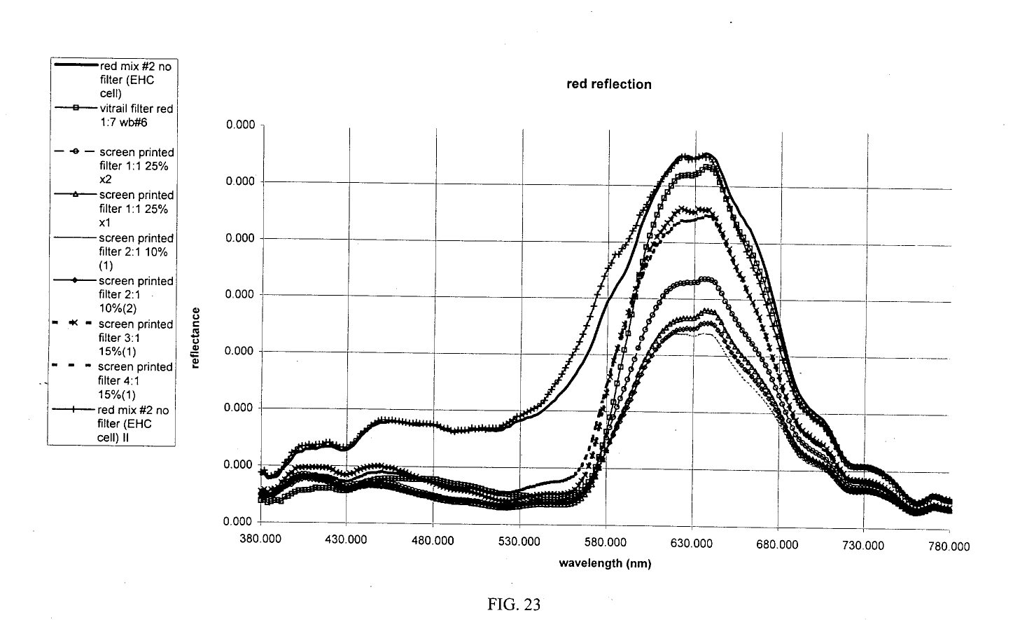

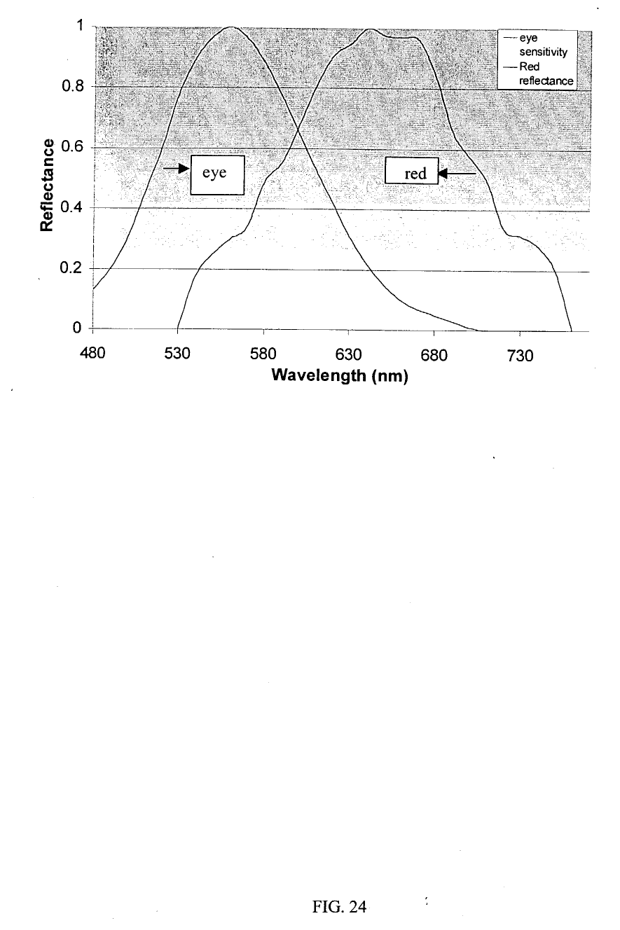

Within the class of embodiments of the present invention wherein the target enhancement region is on a visual perception spectrum, one variation relates to A Psychophysical Perception Enhancement wherein the target enhancement region is on a red side of the visual perception spectrum. See the end of the detailed description of the invention section and FIGS. 4-33 for summary and data related to best enabling mode of this filter as applied to LCD.

Within the class of embodiments of the present invention wherein the target enhancement region is on a visual perception spectrum, another variation relates to A Psychophysical Perception Enhancement wherein the target enhancement region is on a violet side of the visual perception spectrum.

Within the class of embodiments of the present invention wherein the target enhancement region is on a visual perception spectrum, a further variation relates to A Psychophysical Perception Enhancement wherein the target enhancement region is on the visual perception spectrum, substantially between a red side and a violet side of the spectrum. Here, in principal, there could be two filters, one applied to an upper limit of the target region and the other applied to a lower limit of the target region.

Within the class of embodiments of the present invention wherein the target enhancement region is on a visual perception spectrum, a still further variation relates to A Psychophysical Perception Enhancement wherein applying a filter includes embodying said filter as a pigmented layer placed substantially parallel to the perceptible output spectrum. According to the general paradigm of the present invention, the aspect of substantially parallel if not strictly required, since there are geometric features of the perceiver that could be convolved with the filter embodiment.

Within the class of embodiments of the present invention wherein the target enhancement region is on a visual perception spectrum, a different variation relates to A Psychophysical Perception Enhancement wherein applying a filter includes embodying said filter as a digital signal processing circuit for modifying signals that are substantially encoding the perceptible output spectrum. Today, with the enormous color variability available in computer generated images, the filter of the present invention could be embodied as an enhancement to the perceptible features of the representation of the signal, meant to be appreciated with the display or printing of the image.

Within the class of embodiments of the present invention wherein the target enhancement region is on a visual perception spectrum, yet another variation relates to A Psychophysical Perception Enhancement wherein applying a filter includes embodying said filter as a analog electronic circuit for modifying signals that are substantially encoding the perceptible output spectrum. In this context, it is likely that heretofore specification faulty components may prove to have appropriate shape characteristics for building filters according to the present invention.

Within the class of embodiments of the present invention wherein the target enhancement region is on a visual perception spectrum, still another variation relates to A Psychophysical Perception Enhancement wherein applying a filter includes embodying said filter as a passive semitransparent material for modifying output from the perceptible output spectrum. This variation relates to a choice of filtering material that is complementary to the enhancement of the present invention. For example, an improved red perception filter is a red cholesteric mixture with a peak reflection above 600 nm.

Within the class of embodiments of the present invention wherein the target enhancement region is on a visual perception spectrum, yet a further variation relates to A Psychophysical Perception Enhancement wherein the perceptible output spectrum is optically passive. For example, in the choice of a back layer color of a front lit LCD.

Within the class of embodiments of the present invention wherein the target enhancement region is on a visual perception spectrum, another further variation relates to A Psychophysical Perception Enhancement wherein the perceptible output spectrum is optically active. For example, in the choice of a LC mix foe a layer or of an LC-pigment mix for an LC layer.

Within the class of embodiments of the present invention wherein the target enhancement region is on a visual perception spectrum, a different variation relates to A Psychophysical Perception Enhancement wherein the perceptible output spectrum derives from a device selected from the list: a liquid crystal display, an encapsulated liquid crystal display layer, an encapsulated liquid crystal display pixel element, an electric light source, a light bulb, a cathode ray tube, a light emitting surface of a cathode ray tube, a pixel element of a light emitting surface of a cathode ray tube, an incandescent light bulb, a fluorescent light bulb, a halogen light bulb, a mercury vapor light bulb, a neon lighting tube, a light emitting diode, a plasma light source, an arc lamp, or the likes. The specific selection of filters will modify the perceptual sensitivity in the filter proximate region(s)

Within the class of embodiments of the present invention wherein the target enhancement region is on a visual perception spectrum, another new variation relates to A Psychophysical Perception Enhancement wherein applying a filter includes embodying said filter as a coating to an optical element in front of the perceptible output spectrum. For example, as a camera lens coating.

Within the class of embodiments of the present invention wherein the target enhancement region is on a visual perception spectrum, a further new variation relates to A Psychophysical Perception Enhancement wherein applying a filter includes enbodying said filter as a doping in an optical element in front of the perceptible output spectrum. For example, as an additive to a glass, glaze, or plastic.

According to a second class of embodiments of A Psychophysical Perception Enhancement wherein the target enhancement region is on an audio perception spectrum.

Within the class of embodiments of the present invention wherein the target enhancement region is on an audio perception spectrum, one variation relates to A Psychophysical Perception Enhancement wherein the target enhancement region is on a low frequency side of the audio perception spectrum. This enhancement improves sensitivity to vibration, footsteps, or other events for which a work environment (or an entertainment environment) would benefit from improved sensitivity.

Within the class of embodiments of the present invention wherein the target enhancement region is on an audio perception spectrum, one variation relates to A Psychophysical Perception Enhancement wherein the target enhancement region is on a high frequency side of the audio perception spectrum. This is particularly important for elderly persons where high frequency perception sensitivity is normally degraded and amplification in generally an inadequate remedy.

Within the class of embodiments of the present invention wherein the target enhancement region is on an audio perception spectrum, one variation relates to A Psychophysical Perception Enhancement wherein the target enhancement region is on the audio perception spectrum, substantially between a low frequency side and a high frequency side of the spectrum.

Within the class of embodiments of the present invention wherein the target enhancement region is on an audio perception spectrum, one variation relates to A Psychophysical Perception Enhancement wherein applying a filter includes embodying said filter as a sonic-permeable layer placed substantially parallel to the perceptible output spectrum. Audio absorbance testing of materials, such as felt, cloth, perforated films, etc., will allow for the fabrication of composite layered materials in accordance with the paradigm of the present invention. These materials are remarkable as acoustic curtains or as earmuffs, etc., such as for substantially blocking out speech and substantially allowing environmental sound through or the reverse.

Within the class of embodiments of the present invention wherein the target enhancement region is on an audio perception spectrum, one variation relates to A Psychophysical Perception Enhancement wherein applying a filter includes embodying said filter as a digital signal processing circuit for modifying signals that are substantially encoding the perceptible output spectrum.

Within the class of embodiments of the present invention wherein the target enhancement region is on an audio perception spectrum, one variation relates to A Psychophysical Perception Enhancement wherein applying a filter includes embodying said filter as a analog electronic circuit for modifying signals that are substantially encoding the perceptible output spectrum.

Within the class of embodiments of the present invention wherein the target enhancement region is on an audio perception spectrum, one variation relates to A Psychophysical Perception Enhancement wherein applying a filter includes embodying said filter as a passive semitransparent material for modifying output from the perceptible output spectrum. For example, as a speaker cabinet front surface or inversely a speaker cabinet internal back surface; as an inexpensive method for improving the perception of the speaker's output.

Within the class of embodiments of the present invention wherein the target enhancement region is on an audio perception spectrum, one variation relates to A Psychophysical Perception Enhancement wherein the perceptible output spectrum is acoustically passive.

Within the class of embodiments of the present invention wherein the target enhancement region is on an audio perception spectrum, one variation relates to A Psychophysical Perception Enhancement wherein the perceptible output spectrum is acoustically active. For example as a modified phase conjugate element.

Within the class of embodiments of the present invention wherein the target enhancement region is on an audio perception spectrum, one variation relates to A Psychophysical Perception Enhancement wherein the perceptible output spectrum derives from a device selected from the list: a microphone, a microphone of a hearing aid, a microphone of a telephone, an audio codex, a sound amplifier, a signal generator an audio synthesizer, a vibration sensor, a solenoid pickup, a solid-state pickup, a differential sensor, or the likes.

In conjunction with the abovementioned classes of embodiments of A Psychophysical Perception Enhancement, another fundamental class of variations relates to defining the perceptible transition region includes allowing a sufficiently broad region for a normal perceiver to differentiate between two equivalent energy narrow regions that are respectively located at different non-intersecting spectral addresses within the transition region.

Furthermore, in conjunction with the abovementioned classes of embodiments of A Psychophysical Perception Enhancement wherein applying a filter having a spectral shape substantially inverse to normal perception for the transition region includes (A) equating normal perception with a majority of results in statistical sampling of a large population, or (B) equating normal perception with a majority of results in statistical sampling of a population having a predetermined perceptual impairment, or (C) equating normal perception with perception measurements for a predetermined individual.

The present invention also relates to embodiments of A Psychophysical Perception Enhancement Filter compliant with the Psychophysical Perception Enhancement.

Turning to FIG. 3, the present invention furthermore relates to embodiments of A program storage device 301 readable by a machine, tangibly embodying a program of instructions executable by the machine to perform method steps for A Psychophysical Perception Enhancement Filter, said method steps comprising; (a) 302 accepting a designation of a target enhancement region in a perceptible output spectrum and the region is defined as having at least one boundary; (b) 303 accepting a definition of a perceptible transition region that is proximate to one of the boundaries; and (c) in the transition region, 304 applying a filter having a spectral shape substantially inverse to normal perception for the transition region.

With reference to FIGS. 4-33, herein below is presented summary and data related to best enabling mode of this filter as applied to LCD.

1. Red cholesteric mixture—

Blue cholesteric mixture MDA-00-3906

(manufactured by Merck, Germany)

Turn to λ=478 nm

Diluted in X=645 nm

2. Current Best Filters—

(i) Using wirebar application—Vitral glass paints “Bright Red” “Colorless”—Mixed to 1:7 respectively and applied using 60 nm wirebar

(ii) Screen printing application—Wiederhold screen printing inks “Magneta” (z 181/GL NT) and “clean” (Z E 50/GL) mixed to 1:3 respectively and diluted by 15% applied once through 120 mesh screen.

11 Sep. 2002—Mixtures of Purple (Vitrail) w/ Colorless (Vitrail)

| Glass# | PURPLE | COLORLESS | |
|---|---|---|---|
| 1 | 0% | 100% | |
| 2 | 100% | 0% | |
| 3 | (2 drops) 38.1 mg | (8 drops) 167. mg | 1:4 |
| 4 | (6 drops) 124.3 mg | (9 drops) 211.8 mg | 2:3 |

### Destroyed Semples—Acetone Spill

| | | | |
|---|---|---|---|
| 5 | 73.8 mg | 299.6 mg | 1:4 |
| 6 | 69.6 mg | 569.7 mg | 1:8.2 |
| 7 | 23.9 mg | 361.0 mg | 1:15.1 |
| 8 | 19.6 mg | 408.4 mg | 1:20.8 |

### Mixtures of Bright Red (Vitrail) w/ Colorless (Vitrail)

| | | | |
|---|---|---|---|
| 9 | 67 mg | 669.1 mg | 1:10 |
| 10 | 35.0 mg | 700.4 mg | 1:20 |

12 Sep. 2001—Winsor & Newton Colligraphy Ink Crimsou

### Diluted w/ Acetone

| GLASS# | RED (ink) | SOLVENT |
|---|---|---|
| 1 | 217.1 mg | 216.8 mg |

### Glass Solvent

| | | | |
|---|---|---|---|
| 2 | 224.3 mg | 233.1 mg | |
| 3 | 634 mg | 327.9 mg | (Roller oven × 3) |
| 4 | 634 mg | 327.9 mg | |

Transferred 1 ml of old type red cholesteric

Mixture MDA-01-1 to small bottle

Mixture of Marabu Paints—“Black” and “Red” with Vitrail Paints “Colorless”

| GLASS# | “RED” | “BLACK” | “COLORLESS” |
|---|---|---|---|
| 5 | 87.2 mg | 0. | 425.5 mg |

Mixtures of Vitrail Paints “Purple” “Bright Red” and “Colorless”

| GLASS# | “RED” | “PURPLE” | “COLORLESS” | |
|---|---|---|---|---|
| 6 | 61.4 mg | 17.1 mg | 597.8 mg | (36:1:35) |
| 7 | 37.6 mg | 35.9 mg | 673.5 mg | (1:1:18.5) |

Prepared 6 test cell (EHC) filled with MDA-01-1

Painted black the back side of 5 of the cells

4 cell with with filters

| | Bright Red | Purple | Colorless | |
|---|---|---|---|---|
| 1 | 34.3 mg | 11.4 mg | 399.0 mg | (3:1:35) |
| 2 | 18.2 mg | 18.9 mg | 326.9 mg | (2:2:35) |
| 3 | 42.9 mg | 14.3 mg | 1006.5 mg | (3:1:70) |
| 4 | 53.0 mg | 0 mg | 530.1 mg | (1:0:10) |

3 Sep. 2001—Prepared 5 Cells with MDA-00-3908 Red Cholesteric

4 with fitters:

| | Bright Red | Purple | Colorless | |
|---|---|---|---|---|
| 1 | 33.9 mg | 11.7 mg | 403.4 mg | (2.9:1:34.5) |
| 2 | 20.7 mg | 20.9 mg | 380.8 mg | (2:2:36.6) |
| 3 | 44 mg | 14.9 mg | 1007.2 mg | (29:1:68) |
| 4 | 57.1 mg | 0 mg | 582.8 mg | (1:0:10.2) |

16 Sep 2001—Colorless Measurments

| | | | L | A | B | |
|---|---|---|---|---|---|---|
| 1 | Test cell w/no | Sep. 12, 2001 | 20 | 24 | 17 | (#2) |
| | filtter | | | | | |
| 2 | Test cell (1) from | Sep. 12, 2001 | 17 | 32 | 19 | (3) |
| 3 | Test cell (2) from | Sep. 12, 2001 | 13 | 22 | 14 | (4) |
| 4 | Test cell (3) from | Sep. 12, 2001 | 14 | 16 | 13 | (5) |
| 5 | Test cell (4) from | Sep. 12, 2001 | 11 | 20 | 12 | (6) |
| 6 | Test cell (1) from | Sep. 12, 2001 | 16 | 30 | 18 | (7) |
| 7 | Spectra scan | Sep. 12, 2001 | 18 | 33 | 19 | (8) |
| | closer to sample | | | | | |
| | (1) | | | | | |
| 8 | Lights closer to | Sep. 12, 2001 | 21 | 35 | 20 | (9) |
| | sample (1) | | | | | |
| 10 | Spectascan + lights | Sep. 13, 2001 | 12 | 12 | 9 | (10) |
| | back to origen/no | | | | | |
| | filter | | | | | |
| 11 | (1) | Sep. 13, 2001 | 13 | 24 | 16 | (11) |
| 12 | (2) | Sep. 13, 2001 | 19 | 35 | 25 | (12) |
| 13 | (3) | Sep. 13, 2001 | 19 | 29 | 21 | (13) |
| 14 | (4) | Sep. 13, 2001 | 13 | 26 | 16 | (14) |
| 15 | New software (1) | Sep. 12, 2001 | 18 | 35 | 21 | (15) |

Paint Mixtures for CRL

| | “Bright Red | “Purple” | “Colorless” | |
|---|---|---|---|---|
| 1 | 0.6002 g | 0.2009 g | 7.0361 g | (3:1:35) |
| 2 | 0.2033 g | 0 g | 2.0931 g | |
| 3 | 0.7539 g | Of mixture 1 | | |
| | 1.4727 | Of mixture + | 1.3323 | (3:1:35) |

26 Sep. 2001

1:35 mixture of purple+colorless weight 91.7 mg purple, add 3216.5 mg colorless (1:35.1) mixture #1

1:35 mixture of bright red+colorless weight 96.6 mg red, add 3387.4 mg colorless (1:35.1) mixture #2

Color Mixtures Prepared of Base Mixture #1ε#2

| | Red:Purple | | | |
|---|---|---|---|---|
| 1 | (9:1) | 230.1 mg:25.3 mg | Added | (9.07:1) |
| | | +437.6 mg:+48.3 mg | | (9.07:1) #3 |
| 2 | (7:3) | 577.6 mg:254.2 mg | | (7.07:3) #4 |
| 3 | (5:5) | 428.0 mg:416.2 mg + 44 mg | | (5.08:5) #5 |
| 4 | (3:7) | 242.6 mg:567.4 mg | | (2.99:7) #6 |
| 5 | (1:9) | 77.4 mg:703.0 mg | | (0.99:9) #7 |
| 6 | (8:2) | 642.9 mg:153.6 mg | | (8.4:2) #8 |

23 Sep. 2001—Red Base Mixture:

| | | |
|---|---|---|
| Bottle 1: | 215.3 mg red + 7544.4 mg colorless | (1:35) |
| Bottle 2: | 206.2 mg red + 7220.4 mg colorless | (1:35) |

Purple Base Mixture:

| | | |
|---|---|---|
| Bottle 1: | 208.2 mg purple + 7297.2 mg colorless | (1:35) |
| Bottle 2: | 208.2 mg purple + 7320.7 mg colorless | (1:35.2) |

Used Bottle 1 of each Base Mixture:

| | Red purple | | | |
|---|---|---|---|---|
| #1 | 9:1 = | 76 mg purple + 691.5 mg | red | (9.1:1) |
| #2 | 8:2 = | 143 mg purple + 574.9 mg | red | (8:2) |
| #3 | 7:3 = | 225.6 mg purple + 522.3 mg | red | (6.9:3) |
| #4 | 6:6 = | 291.3 mg purple + 440.5 mg | red | (6:4) |
| #5 | 5:5 = | 361.7 mg purple + 368.7 mg | red | (5.1:5) |
| #6 | 4:6 = | 447.5 mg purple + 296.5 mg | red | (4:6) |
| #7 | 3:7 = | 509.6 mg purple + 218.6 mg | red | (3:7) |
| #8 | 2:8 = | 578.2 mg purple + 144.8 mg | red | (2:8) |
| #9 | 1:9 = | 729.8 mg purple + 79.1 mg | red | (1:9) |

Filters Prepared Spreading Color Using Amir's Home Made Wirebar

| | | | | |
|---|---|---|---|---|
| 1. mix #1 | 9:1 | (red:purple) | single layer | y = 0.9449x − 465.43 |
| 2. mix #1 | 9:1 | (red:purple) | double layer | R2 = 6.9982 |
| 3. mix #2 | 8:2 | (red:purple) | single layer | y = 0.878x − 425.48 |
| 4. mix #2 | 8:2 | (red:purple) | double layer | R2 = 0.9981 |
| 5. mix #3 | 7:3 | (red:purple) | single layer | y = 0.8443x − 405.52 |
| 6. mix #3 | 7:3 | (red:purple) | double layer | R2 = 0.998 |
| 7. mix #4 | 6:4 | (red:purple) | single layer | y = 0.8255x − 394.5 |
| 8. mix #4 | 6:4 | (red:purple) | double layer | R2 = 0.9978 |
| 9. mix #5 | 5:5 | (red:purple) | single layer | Y = 0.7366x − 34229 |
| 10. mix #5 | 5:5 | (red:purple) | double layer | R2 = 0.9973 |
| 11. mix #6 | 4:6 | (red:purple) | single layer | y = 0.7146x − 329.09 |
| 12. mix #6 | 4:6 | (red:purple) | double layer | R2 = 0.9974 |
| 13. mix #7 | 3:7 | (red:purple) | single layer | y = 0.6717x303.62 |
| 14. mix #7 | 3:7 | (red:purple) | double layer | R2 = 6.9978 |
| 15. mix #8 | 2:8 | (red:purple) | single layer | y = 0.6613x − 297.65 |
| 16. mix #8 | 2:8 | (red:purple) | double layer | R2 = 0.9975 |
| 17. mix #9 | 1:9 | (red:purple) | single layer | y = 0.6047x − 264.31 |
| 18. mix #9 | 1:9 | (red:purple) | double layer | R2 = 0.9973 |

| | | | |
|---|---|---|---|
| Red base mix | (red:purple) | single layer | y = 0.5919x − 257.25 |
| | | | R2 = 0.9977 |
| Purple base mix | (red:purple) | single layer | y = 0.9894x − 491.91 |
| | | | R2 = 0.9984 |

Turning now to FIG. 4

11 Oct. 2002—Transfer 1.5 ml of BLO87 to Small Bottle Cholesteric Red Mixture.

Start with cholesteric blue λ=478 nm (MDA-00-3906) add

1. 181.8 mg (3906)+93.6 mg (BLO87)=724 nm—+106.1 mg (39606)

247.9 mg (3906)+93.6 mg (BLO87)=633 nm

2. 307.7 mg (3906)+107.9 mg (BLO87=645 nm

3. 348.3 mg (3906)+107.8 mg (BLO87)=625.9 nm

4. 437.0 mg (3906)+119.7 mg (BLO87)=608.9 nm

14 Oct. 2002—Paint Mixtures—Base Mixture of Vtrail Red and Purple or 1:17 w/ Colorless

Red: 284.3 mg red+4833.2 mg colorless (1:17)

Purple: 277.9 mg+4729.3 mg colorless (1:17)

Red Filter results—The main problem in making an emissive color display using cholesteric liquid crystals, is the red color of the RGB. In this paper we show how to choose the best combination between the red filter and the spectral sensitivity of the hman eye, in order to creat a red layer.

Introduction: Cholesteric liquid crystals are used in reflective displays. The Cholesteric liquid crystal acts as an internal Bragg-reflector, and therefore needs no polarizers or reflector. Different reflected colors are achieved by using tunable chiral materials. Although it is possible to prepare a mixture with a central wavelength that is red, it's reflected color is never seen as red. The reason behind this problem is the combination between the intrinsic waveband of the cholesteric reflection and the spectral sensitivity of the human eye. The bandwidth is dependant on the central wavelength of the mixture. The longer the central wavelength is, the wider the sidebands become. This means that for any mixture with a red spectrum, there is an orange side band. Since the eye is much more sensitive to orange colors then it is to reds, the reflection appears to have an orange shift. There are a few ways to deal with the orange sideband, the most commonly known are either using a filter in front of the red layer, or doping the cholesteric material with dyes. The second method creates problem both in the driving of the display and in the stability of the mixture.

Experimental Set Up: Measurement Set Up

Reflection spectra were measured with the Photoresearch, Spectrascan 704.

Transmission spectra were measured with the Unico 2100 spectrophotometer.

Material and Method:

Red Cholesteric mixture

In order to get a cholesteric mixture with a red central wavelength, nematic material BL087 was added to the blue cholesteric mixture (between 20 and 25% BL087):

| | | Weight of blue | Weight of | % weight of | Calculated central |
|---|---|---|---|---|---|
| Mix # | | mix | BL087 | BL087 | wavelength |
| | 1. | 287.9 g | 93.6 g | 24.5% | 633 nm |
| | 2. | 307.7 g | 107.9 g | 25.9% | 645 nm |
| | 3. | 348.3 g | 107.8 g | 23.6% | 626 nm |
| | 4. | 437.0 g | 119.7 g | 21.5% | 609 nm |

*The initial wavelength of the blue mixture is 478 nm.

Red Filter Colors

The filters for the cells were made using Vitrail transparent colors for glass (manufactured byLefranc & Bourgeois). The colors used for the filters were prepared by mixing three manufacturer colors, Bright Red, Purple and Colorless.

The filters were prepared using a 20 micron wire bar, either on microscope sample slides or directly on Liquid Crystal Test Cells.

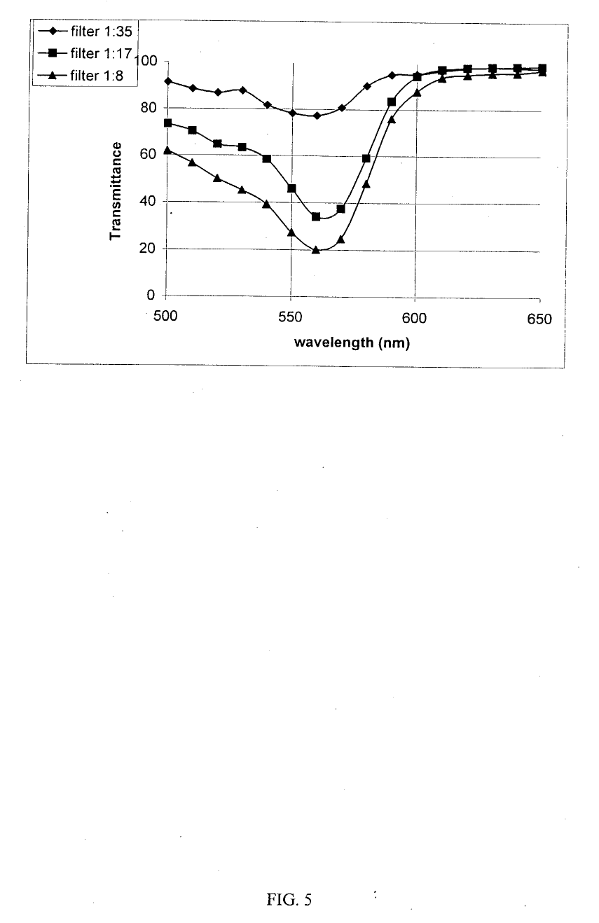

Results: Initialy the filters used were a mixture of diluted red and purple paints. The colors were diluted by mixing each one with the colorless in one part colored ink for every 35 parts of the colorless ink. Different mixture ratios of the red and purple colors were used and their spectra measured: (see FIG. 5)

The results of the Spectra showed the difference between the different color combinations was not in the peak wavelength of the filters but in the absolute reduction of the colors—the slant angle in which the orange was absorbed by the filter.

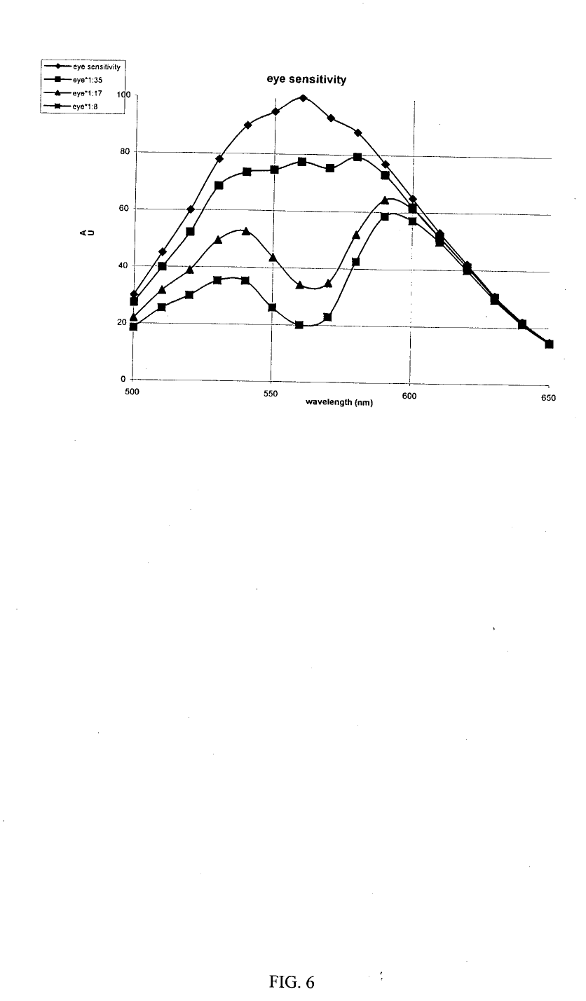

Since the purpose is to maximize the reduction of the orange sideband, different dilution ratio's of the red ink were measured. (see FIG. 6)

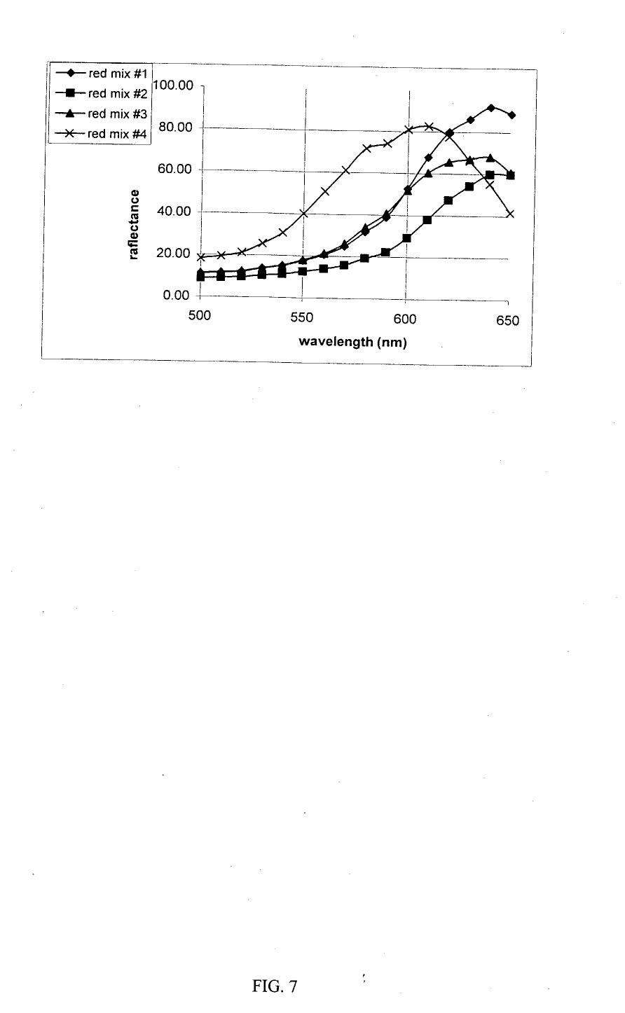

The filters change the effective spectral sensitivity of the eye: (see FIG. 7)

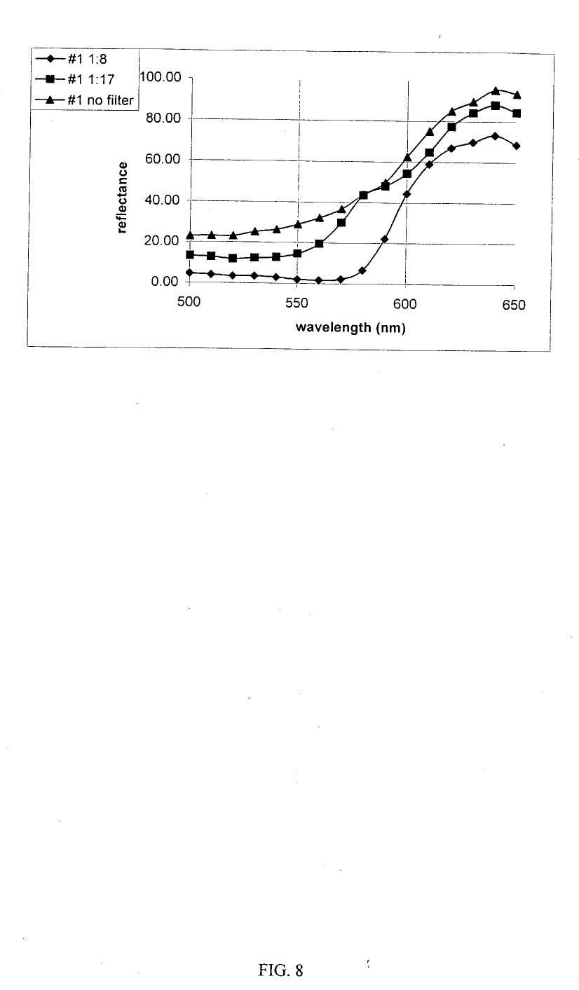

The reflected spectra of the 4 mixtures of cholesteric LC's were measured. FIG. 8 shows the spectra of the 4 mixtures themselves:

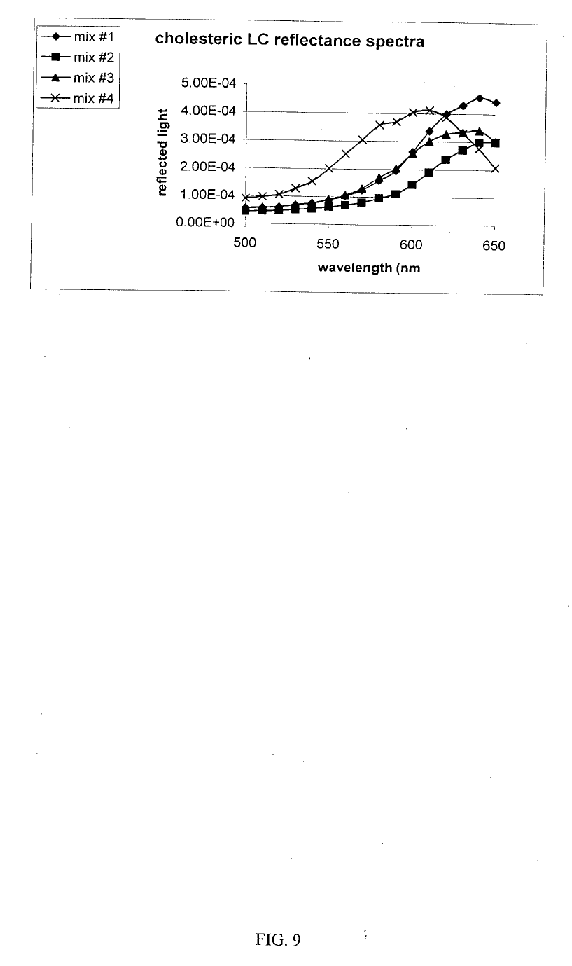

FIG. 9 shows the relative effect of the two different red filters on mix #1.

Discussion:—The difference between the spectra of the different filters was not in their peak absorption wavelength as first expected but in the rate of change in their absorption.

Although the peak wavelength of the absorption of the filters didn't change, the effect of the different filters was apparent when looking at the reflection spectra of the red cholesteric mixtures with the different filters on them. We found that the change to the reflection spectra was caused not by the peak of the filter, but by the effect the rate of change of the absorption, affected the relative sensitivity of the human eye.

In order to achieve a red color for the ChLC, the sensitivity of the eye around 570 nm had to be minimized. The greater the rate of change in the transmition spectra of the filters, the greater the reduction in the required area of the spectral eye sensitivity.

Choosing the red cholesteric mixture that will work best with the filter, requires using a mixture whose peak reflection is above 600 nm. Below 600 nm the filter interferes with the reflection of the cholesteric LC itself.

| Wavelength | #1; no filter | #1; 1:35 | #1; 1:17 | #1; 1:8 | #2; no filter | #2; 1:35 | #2; 1:17 | #2; 1:8 |
|---|---|---|---|---|---|---|---|---|
| 500 | 33.7 | 32.6 | 25.7 | 21.4 | 37.6 | 27.9 | 24.6 | 17.8 |
| 510 | 29.7 | 28.2 | 25.3 | 20.9 | 35.8 | 27 | 25.2 | 19.2 |
| 520 | 28 | 29 | 23.3 | 16.5 | 35.6 | 24.7 | 24.4 | 16.2 |
| 530 | 26.6 | 24.8 | 20.8 | 15.6 | 36.1 | 22.3 | 19.5 | 14.7 |
| 540 | 26.5 | 24.2 | 18.3 | 13.9 | 35.1 | 20.7 | 18.1 | 13.7 |
| 550 | 23.7 | 21.9 | 12.4 | 8.8 | 32.3 | 16.1 | 12.1 | 7.5 |
| 560 | 21.8 | 17.5 | 9.2 | 4.6 | 30.8 | 12.1 | 9.1 | 4 |
| 570 | 19.1 | 14.5 | 9.1 | 5.2 | 25.8 | 11.4 | 8.2 | 3.7 |
| 580 | 16.7 | 15.5 | 11.3 | 8.2 | 19.8 | 13.5 | 12.3 | 7.4 |
| 590 | 13.7 | 13.7 | 13.7 | 12.2 | 17.2 | 14.1 | 14 | 11.7 |
| 600 | 12.4 | 13.5 | 14.4 | 13.2 | 15 | 13.8 | 14.2 | 13 |
| 610 | 11.4 | 12.7 | 12.1 | 13.9 | 13.8 | 13.6 | 13 | 12.2 |
| 620 | 14 | 13 | 11.9 | 13.4 | 13.5 | 12.3 | 13.8 | 11.6 |
| 630 | 10.7 | 13.8 | 12.2 | 13.8 | 12.2 | 12.4 | 12.5 | 12.3 |
| 640 | 12 | 13.5 | 11.5 | 13 | 12.5 | 11.9 | 12.3 | 11.9 |
| 650 | 11.3 | 14 | 11.9 | 12.5 | 11.8 | 12.2 | 12.4 | 12.6 |
| | | | | | Nov. 6, 2001 | Nov. 6, 2001 | | |

| filter 1:35 | filter 1:17 | filter 1:8 | calibration filter | cell |
|---|---|---|---|---|
| 84.4 | 67.8 | 57.2 | 92.3 | 72.4 |
| 81.8 | 65 | 52.3 | 92.3 | 74 |
| 80.2 | 59.8 | 46.2 | 92.3 | 78.7 |
| 78.3 | 58.5 | 41.7 | 92.3 | 74.5 |
| 75.4 | 54 | 36.2 | 92.3 | 77.3 |
| 72.3 | 42.4 | 25.3 | 92.3 | 79.4 |
| 71.4 | 31.5 | 18.6 | 92.3 | 75.7 |
| 74.6 | 34.6 | 22.8 | 92.2 | 81.7 |
| 83.2 | 54.6 | 44.6 | 92.2 | 75.3 |
| 87.6 | 77.1 | 70.2 | 92.2 | 83.1 |
| 87.9 | 87.1 | 81.1 | 92.3 | 76.1 |
| 89.2 | 89.7 | 86.6 | 92.2 | 83.4 |
| 90.2 | 90.4 | 87.7 | 92.2 | 77.8 |
| 90.6 | 90.6 | 88.2 | 92.1 | 82.1 |
| 90.4 | 90.8 | 88.4 | 92.2 | 82.1 |
| 90 | 90.9 | 89 | 92.1 | 78.7 |

| | | | | | calibrated: | | |
|---|---|---|---|---|---|---|---|
| Wavelength | mix #1 | mix #2 | mix #3 | mix #4 | filter 1:35 | filter 1:17 | filter 1:8 |
| 500 | 5.27E−05 | 6.25E−05 | 7.05E−05 | 9.61E−05 | 91.44095 | 73.45612 | 61.97183 |
| 510 | 5.32E−05 | 6.58E−05 | 7.53E−05 | 9.99E−05 | 88.62405 | 70.42254 | 56.66306 |
| 520 | 5.31E−05 | 6.61E−05 | 7.68E−05 | 9.83E−05 | 86.89057 | 64.78873 | 50.05417 |
| 530 | 5.78E−05 | 7.21E−05 | 8.82E−05 | 1.08E−04 | 84.83207 | 63.38028 | 45.17876 |
| 540 | 6.06E−05 | 7.94E−05 | 1.02E−04 | 1.18E−04 | 81.69014 | 58.50488 | 39.21993 |
| 550 | 6.68E−05 | 8.91E−05 | 1.21E−04 | 1.36E−0.4 | 78.33153 | 45.93716 | 27.41062 |
| 560 | 7.43E−05 | 9.68E−05 | 1.43E−04 | 1.53E−04 | 77.35645 | 34.12784 | 20.15168 |
| 570 | 8.45E−05 | 1.14E−04 | 1.79E−04 | 1.89E−04 | 80.91106 | 37.52711 | 24.72885 |
| 580 | 1.01E−04 | 1.44E−04 | 2.27E−04 | 2.42E−04 | 90.23861 | 59.21909 | 48.3731 |
| 590 | 1.15E−04 | 1.70E−04 | 2.49E−04 | 2.72E−04 | 95.01085 | 83.62256 | 76.13883 |
| 600 | 1.44E−04 | 2.12E−04 | 2.79E−04 | 3.17E−04 | 95.23294 | 94.3662 | 87.86566 |
| 610 | 1.73E−04 | 2.48E−04 | 2.93E−04 | 3.50E−04 | 96.7462 | 97.2885 | 93.92625 |
| 620 | 1.96E−04 | 2.79E−04 | 2.95E−04 | 3.73E−04 | 97.8308 | 98.04772 | 95.11931 |
| 630 | 2.06E−04 | 2.98E−04 | 2.75E−04 | 3.77E−04 | 98.37134 | 98.37134 | 95.76547 |
| 640 | 2.19E−04 | 3.11E−04 | 2.40E−04 | 3.66E−04 | 98.04772 | 98.48156 | 95.87852 |
| 650 | 2.15E−04 | 2.88E−04 | 1.89E−04 | 3.11E−04 | 97.71987 | 98.69707 | 96.63409 |

| | | | | | calibrated: | | | eye |
|---|---|---|---|---|---|---|---|---|
| wavelength | mix #1 | mix #2 | mix #3 | mix #4 | filter 1:35 | filter 1:17 | filter 1:8 | sensitivity |
| 500 | 13.96 | 16.55 | 18.68 | 25.46 | 91.44095 | 73.45612 | 61.97183 | 30 |
| 510 | 14.11 | 17.43 | 19.96 | 26.47 | 88.62405 | 70.42254 | 56.66306 | 45 |
| 520 | 14.07 | 17.51 | 20.34 | 26.06 | 86.89057 | 64.78873 | 50.05417 | 60 |
| 530 | 15.31 | 19.11 | 23.38 | 28.67 | 84.83207 | 63.38028 | 45.17876 | 78 |
| 540 | 16.06 | 21.03 | 26.92 | 31.35 | 81.69014 | 58.50488 | 39.21993 | 90 |
| 550 | 17.69 | 23.61 | 32.17 | 35.90 | 78.33153 | 45.93716 | 27.41062 | 95 |
| 560 | 19.67 | 25.66 | 37.92 | 40.62 | 77.35645 | 34.12784 | 20.15168 | 100 |
| 570 | 22.38 | 30.07 | 47.40 | 50.13 | 80.91106 | 37.52711 | 24.72885 | 93 |
| 580 | 26.76 | 38.24 | 60.02 | 64.10 | 90.23861 | 59.21909 | 48.3731 | 88 |
| 590 | 30.47 | 44.99 | 65.92 | 71.99 | 95.01085 | 83.82256 | 76.13883 | 77 |
| 600 | 38.16 | 56.17 | 73.87 | 83.94 | 95.23204 | 94.3662 | 87.86566 | 65 |
| 610 | 45.81 | 65.77 | 77.64 | 92.61 | 96.7462 | 97.2885 | 93.92625 | 53 |
| 620 | 51.80 | 73.95 | 78.25 | 98.89 | 97.8308 | 98.04772 | 95.11931 | 42 |
| 630 | 54.61 | 78.83 | 72.79 | 100.00 | 98.37134 | 98.37134 | 95.76547 | 31 |
| 640 | 58.08 | 82.27 | 63.62 | 96.85 | 98.04772 | 98.48156 | 95.87852 | 22 |
| 650 | 57.00 | 76.29 | 50.13 | 82.49 | 97.71987 | 98.69707 | 96.63409 | 15 |

| | | | calibrated | | | | |
|---|---|---|---|---|---|---|---|
| | #2 no filter | #2 1:8 | #2 no filter | #2 1:8 | filter 1:8 | eye sensitivity | calibrated eye |
| 500 | 4.44E−05 | 2.49E−05 | 11.78 | 6.58 | 61.97183 | 30 | 18.5915493 |
| 510 | 4.60E−05 | 2.20E−05 | 12.18 | 5.82 | 56.66306 | 45 | 25.49837486 |
| 520 | 4.79E−05 | 1.81E−05 | 12.68 | 4.79 | 50.05417 | 60 | 30.03250271 |
| 530 | 5.25E−05 | 1.82E−05 | 13.92 | 4.81 | 45.17876 | 78 | 35.23943662 |
| 540 | 5.63E−05 | 1.58E−05 | 14.92 | 4.18 | 39.21993 | 90 | 35.2979415 |
| 550 | 6.30E−05 | 9.84E−06 | 16.69 | 2.61 | 27.41062 | 95 | 26.04008667 |
| 560 | 7.00E−05 | 7.31E−06 | 18.55 | 1.94 | 20.15168 | 100 | 20.15167931 |
| 570 | 7.96E−05 | 1.09E−05 | 21.09 | 2.88 | 24.72885 | 93 | 22.9978308 |
| 580 | 9.64E−05 | 3.35E−05 | 25.55 | 8.87 | 48.3731 | 88 | 42.56832972 |
| 590 | 1.12E−04 | 1.05E−04 | 29.57 | 27.87 | 76.13883 | 77 | 58.62689805 |
| 600 | 1.46E−04 | 2.07E−04 | 38.77 | 54.93 | 87.86566 | 65 | 57.11267606 |
| 610 | 1.90E−04 | 2.75E−04 | 50.42 | 72.81 | 93.92625 | 53 | 49.78091106 |
| 620 | 2.37E−04 | 3.13E−04 | 62.88 | 82.99 | 95.11931 | 42 | 39.95010846 |
| 630 | 2.71E−04 | 3.32E−04 | 71.81 | 88.08 | 95.76547 | 31 | 29.68729642 |
| 640 | 3.00E−04 | 3.54E−04 | 79.41 | 93.75 | 95.87852 | 22 | 21.09327549 |
| 650 | 2.99E−04 | 3.42E−04 | 79.33 | 90.73 | 96.63409 | 15 | 14.49511401 |
| | 3.77E−04 | 3.77E−04 | | | | | |

| red LC | MDA-01-1 | | | red LC | MDA-00-3908 | | | | | | |
|---|---|---|---|---|---|---|---|---|---|---|---|
| filter | L | a | b | filter | L | a | b | | | | |
| clear | 20 | 24 | 17 | clear | 12 | 12 | 9 | filters: | red dye | purple dye | colorless |
| 1 | 17 | 32 | 19 | 1 | 13 | 24 | 16 | | 3 | 1 | 35 |
| 2 | 13 | 22 | 14 | 2 | 19 | 35 | 25 | | 2 | 2 | 35 |
| 3 | 14 | 16 | 18 | 3 | 19 | 29 | 21 | | 3 | 1 | 70 |
| 4 | 11 | 20 | 12 | 4 | 13 | 26 | 16 | | 1 | 0 | 10 |

*filter dye concentration is calculated by relative weights

| red mix | filter type | L | a | b | reflectance | ref * a | x | y | |
|---|---|---|---|---|---|---|---|---|---|
| Nov. 10, 2001 #1 | none | 31.53 | 22.89 | 17.56 | 6.88 | 157.4832 | 0.4607 | 0.3528 | 1.158281 |
| Nov. 10, 2001 #1 | purple | 25.17 | 25.08 | 18.89 | 4.47 | 112.1076 | 0.4968 | 0.3517 | 1.133731 |
| Nov. 10, 2001 #1 | red | 24.25 | 26.30 | 19.11 | 4.18 | 109.8551 | 0.5064 | 0.3489 | 1.124174 |
| Nov. 10, 2001 #1 | schott 610 1 mm | 10.42 | 33.26 | 14.00 | 1.18 | 39.28006 | 0.6241 | 0.3044 | 1.061793 |
| Nov. 10, 2001 #1 | R9:P1 | 21.98 | 25.38 | 20.95 | 3.51 | 89.0838 | 0.5216 | 0.3562 | 1.134656 |
| Nov. 10, 2001 #1 | R8:P2 | 21.13 | 25.20 | 20.67 | 3.28 | 82.656 | 0.524 | 0.3556 | 1.132846 |
| Nov. 10, 2001 #1 | schott 610 2 mm | 9.27 | 28.04 | 11.17 | 1.03 | 28.99336 | 0.5876 | 0.311 | 1.058417 |
| Nov. 10, 2001 #1 | schott 590 2 mm | 10.06 | 29.64 | 13.90 | 1.13 | 33.58212 | 0.6128 | 0.3194 | 1.078456 |
| Nov. 10, 2001 #2 | none | 36.79 | 27.00 | 23.40 | 9.43 | 254.502 | 0.479 | 0.3601 | 1.162178 |
| Nov. 10, 2001 #2 | red | 30.31 | 32.82 | 23.95 | 6.36 | 208.8665 | 0.5219 | 0.3479 | 1.117971 |
| Nov. 10, 2001 #2 | schott 610 1 mm | 15.12 | 39.21 | 19.92 | 1.93 | 75.75372 | 0.6264 | 0.3055 | 1.064214 |
| Nov. 10, 2001 #3 | none | 40.98 | 21.94 | 26.62 | 11.85 | 259.989 | 0.4634 | 0.3773 | 1.217092 |
| Nov. 10, 2001 #3 | red | 33.78 | 31.05 | 24.47 | 7.90 | 245.3571 | 0.5048 | 0.3542 | 1.135844 |
| Nov. 10, 2001 #3 | schott 610 1 mm | 12.47 | 31.91 | 15.31 | 1.48 | 47.16298 | 0.5952 | 0.3131 | 1.063722 |
| Nov. 10, 2001 #4 | none | 44.16 | 26.52 | 24.36 | 13.95 | 369.954 | 0.4609 | 0.3622 | 1.181223 |
| Nov. 10, 2001 #4 | red | 31.71 | 36.75 | 28.96 | 6.96 | 255.6698 | 0.5455 | 0.3506 | 1.119815 |
| Nov. 10, 2001 #4 | schott 610 1 mm | 16.73 | 32.18 | 15.95 | 2.25 | 72.30846 | 0.5566 | 0.3163 | 1.060138 |

| | | |
|---|---|---|
| condition = | x >= 0.55 | <=1.095 |

| | | | | | | | | | |
|---|---|---|---|---|---|---|---|---|---|
| #1 | none | 39.75 | 36.33 | 32.30 | 11.10 | 403.263 | 0.5236 | 0.3612 | 1.144294 |
| #1 | red 1:8 | 29.00 | 48.98 | 32.82 | 5.84 | 286.0432 | 0.6069 | 0.325 | 1.084808 |
| #2 | none | 32.04 | 28.98 | 23.11 | 7.11 | 206.0478 | 0.4998 | 0.3551 | 1.13977 |
| #2 | red 1:8 | 28.43 | 47.92 | 30.41 | 5.62 | 269.3104 | 0.5998 | 0.323 | 1.079779 |
| #3 | none | 38.62 | 30.03 | 29.25 | 10.4 | 312.312 | 0.5009 | 0.3677 | 1.16683 |
| #3 | red 1:8 | 30.90 | 48.40 | 31.34 | 6.61 | 319.924 | 0.5913 | 0.3268 | 1.083394 |
| #4 | none | 49.08 | 19.78 | 35.95 | 17.7 | 350.106 | 0.4648 | 0.3987 | 1.272051 |
| #4 | red 1:8 | 28.73 | 41.69 | 28.01 | 5.73 | 238.8837 | 0.5715 | 0.3344 | 1.091994 |
| | | 1.260704 | 1.587156 | | | | | | |
| | | 1.152165 | 1.952951 | | | | | | |
| | | 24.16667 | 40.81667 | 27.35 | 4.8666667 | | | | |

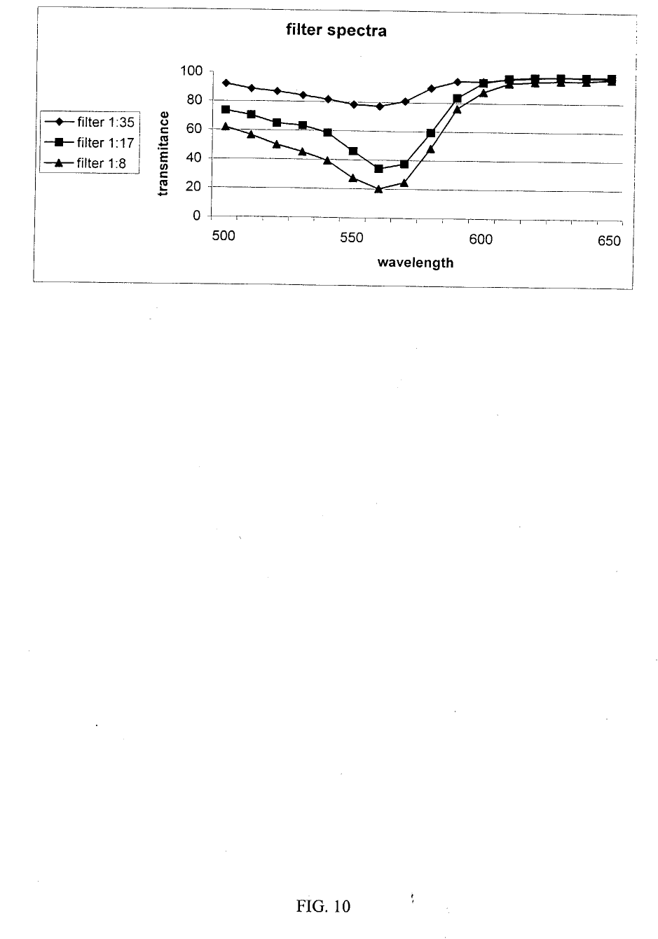

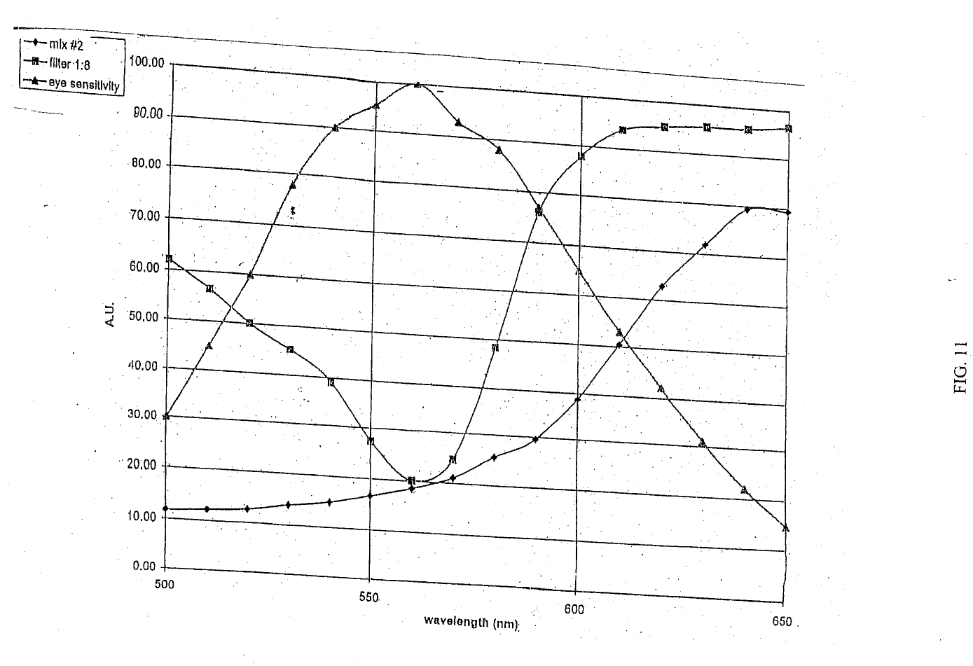

Turning now to FIGS. 10-24

2 Dec. 2002

Red cholesteric mixture—same as mix #2 of 11.10 relative components

2.85 (3906): 1 (BLO87)

Mixed: BLO87-0.4025 g

MDA-00-3906-1.1498 g

Relative amnt.=1: 286

2 Dec. 2002

Red filter mixtures:

(1:4)=6.9960 g red+3.9950 g Colorless=1:4.011

(1:5)=0.8450 g red+4.2507 g colorless=1:5.03

(1:6)=0.7181 g red+4.3585 g colorless=1:5.99

(1:7)=0.6389 g red+4.4689 g colorless=1:6.99

(1:8)=0.5640 red+4.5281 g colorless=1:803

6 Dec. 2002

rcc formula—define a “good” red

rcc—X2+Y2 if X>0.55 and rcc

X-0.17

| Cell Type | Filter | File name | X | Y | Rcc |
|---|---|---|---|---|---|
| E.H.C 6UM | 1:8 wb#6 | 61201R.txt | 0.61 | 0.32 | 1.078 |
| | 1:4 wb#6 | 61202R.txt | 0.64 | 032 | 1.089 |
| | 1:7 wb#6 | 61203R.txt | 0.61 | 032 | 1.078 |
| | 1:6 wb#6 | 61204R.txt | 0.63 | 0.32 | 1.085 |
| | 1:8 wb#4 | 61205R.txt | 0.575 | 0.33 | 1.085 |
| | 1:4 wb#4 | 61206R.txt | 0.61 | 0.33 | 1.078 |
| | 1:6 wb#4 | 61207R.txt | 0.59 | 0.32 | 1.072 |
| | 1:4 wb#3 | 61208R.txt | 0.62 | 0.32 | 1.082 |
| | 1:6 wb#3 | 61208R.txt | 0.57 | 0.33 | 1.085 |
| | 1:8 wb#6 | 61210R.txt | 0.59 | 0.32 | 1.073 |

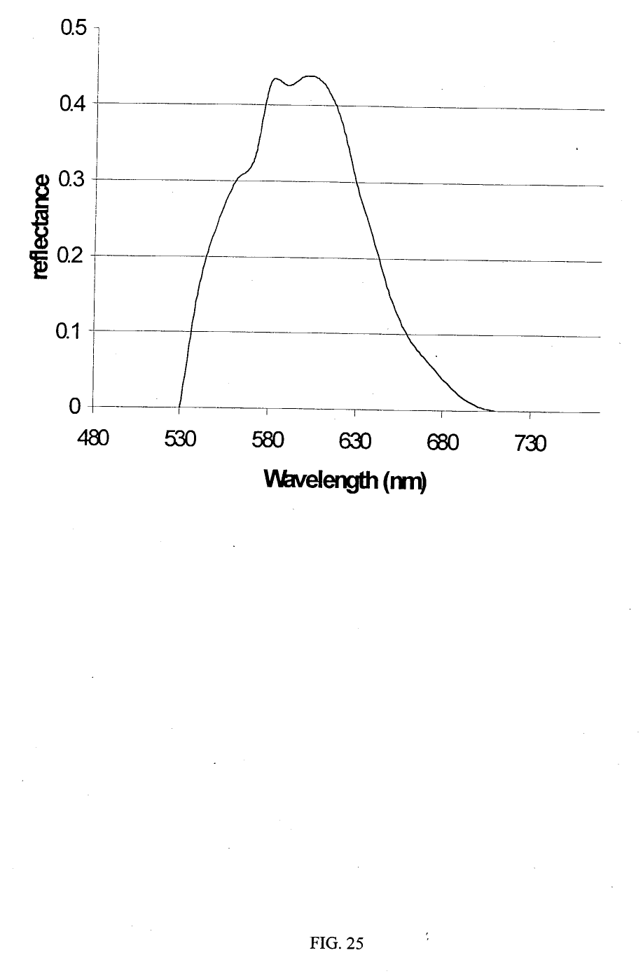

*Visible decay in planer state

| Cell Type | Filter | File name | X | Y | rcc |
|---|---|---|---|---|---|
| | ″ | 61212R.txt | 0.62 | 0.32 | 1.082 |
| RL SE | 1:8 wb#6 | 61212R.txt | 0.63 | 0.33 | 10099 |
| | 1:4 wb#6 | 61213R.txt | 0.66 | 0.32 | 1.098 |
| | 1:6 wb#4 | 61214R.txt | 0.62 | 0.33 | 1.096 |
| | 1:6 wb#3 | 31215R.txt | 0.61 | 0.34 | |

| Red filter measurements: | | | File Name |
|---|---|---|---|
| 15/0102 | | | |
| 1. Sample filter 6.12.01 | | 1:7 wb#6 | 1501 red 1.txt |
| 2. Sample filter 6.12.01 | | 1:8 wb#6 | 1501 red 2.txt |
| 3. 1 clear: 1 magenta (color) × 2 25% diluted | | | 1501 red 3.txt |
| 4. 1 clear: 1 magenta (color) × 2 40% diluted | | | 1501 red 4.txt |
| 5. 4 clear: 1 color | | 15% (1) | 1501 red 5.txt |
| 6. 4 clear: 1 color | | 15% (2) | 1501 red 6.txt |
| 7. 3 clear: 1 color | | 15% (1) | 1501 red 7.txt |
| 8. 3 clear: 1 color | | 15% (2) | 1501 red 8.txt |
| 9. 2 clear: 1 color | | 10% (1) | 1501 red 9.txt |
| 10. 2 clear: 1 color | | 10% (2) | 1501 red 10.txt |
| 11. 1 clear: 1 color | x3 | 40% | 1501 red 11.txt |
| 12. 1 clear: 1 color | | 25% (1) | 1501 red 12.txt |
| 13. 3 clear: 1 color | x2 | 15% | 1501 red 13.txt |
| 14. 1 clear: 1 color | | 40% | 1501 red 14.txt |
| 16.01.02 | | | |
| 1. EHC cell filter w/mix # 2 | | | 1601 red 1.txt |
| L = 48.8 a = 26.5 b = 22.3 | | | |
| 2. EHC cell + 1:7 wb # 6 filter | | | 1601 red 2.txt |
| L = 31.1 a = 42.5 b = 23.7 | | | |
| 3. EHC cell + 1 clear: 1 color × 2 | | | 1601 red 3.txt |
| 25% filter | | | |
| L = 26.6 a = 37.6 b = 17.9 | | | |
| 4. EHC cell + 1:1 × 1 25% | | | 1601 red 4.txt |
| L = 24.6 a = 35.4 b = 15.8 | | | |
| 5. EHC cell + 2:1 10% (2) | | | 1601 red 5.txt |
| 6. EHC cell + 2:1 10% (2) | | | 1601 red 6.txt |
| 17.01.02 | | | |
| 1. EHC cell filter w/mix #2 | | | 1701 red 1.txt |
| 2. EHC cell + 3:1 15% filter (1) | | | 1701 red 2.txt |
| 3. EHC cell + 4:1 15% filter (1) | | | 1701 red 3.txt |
| see FIGS. 25 | | | |

Best LCD Enablement—Summary

Psychophysical perception enhancement of red cholesteric liquid crystal films improves the total performance of a full color outdoor cholesteric display. The reflection of a ‘red’ cholesteric liquid crystal mixture usually appears brown due to the eye seeing the shorter wavelength overtone bands more effectively. A technique to improve the perceived red color without lowering the stability of the liquid crystal mixture is presented. The method also improves the entire RGB color triangle.

Summary—Objectives and background—Unlike in most reflective displays, in a three-layer stacked SCT device, the full area of the display is used to reflect each color thus giving high reflectance (J. L. West, V. Bondar, Asia Display '99, p 29.; X.-Y. Huang, A. Khan, D. Davis, C. Jones, N. Miller, J. W. Doane, Asia Display '98, p.883-886.). Due to their bistability they are attractive for large area displays. Our target was to compete with large area printed color images. We chose SCT to do this; and have been largely successful. This study aims to improve the normally poor red color and while some techniques have been suggested (P. Kipfer, R. Klappert, J. M. Kunzi, H. P. Herzig, Freiburg Liquid Crystal Conference 1999: Paper number 8.; S. Miyashita, Information Display 4&5, 2002: p.16-19); they compromise the light stability of the device, and its optical performance. This study aimed at a method to improve the red color with minimal loss in brightness and light stability.

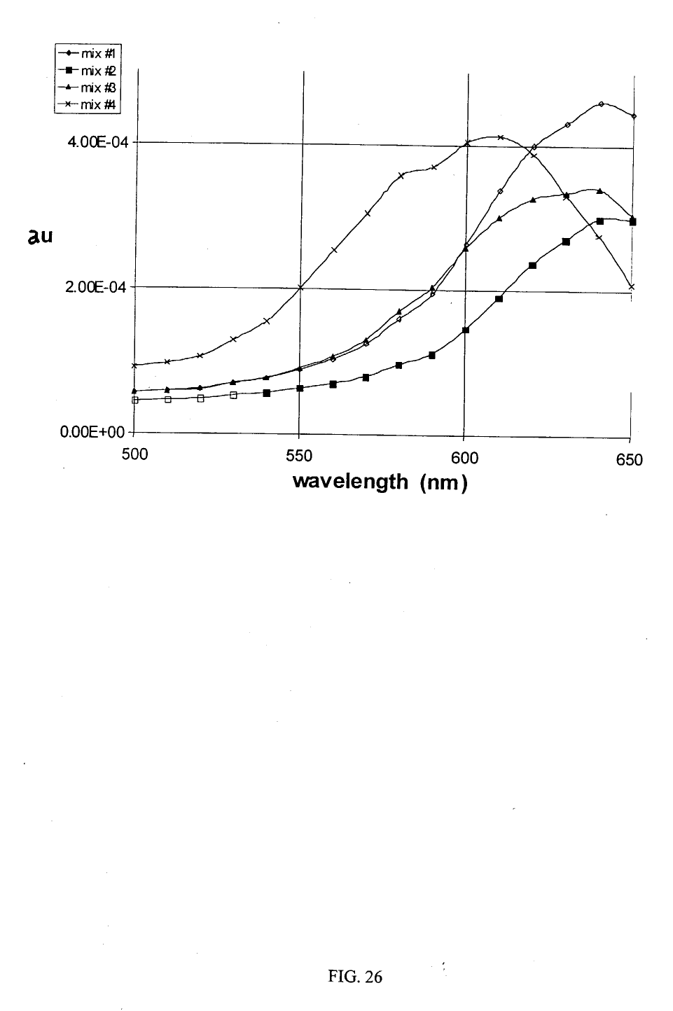

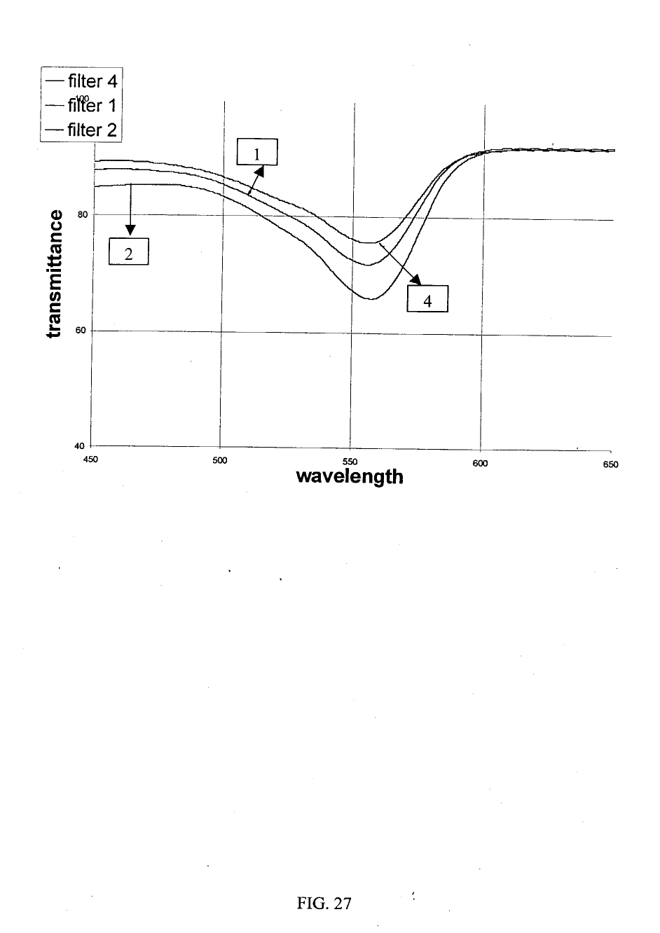

FIG. 26—Spectra of the spectral eye sensitivity and of a typical red ChLC reflectance. FIG. 27—After combining the two spectra in figure A, □max is shifted towards shorter wavelengths and appears ‘orange’.

In a cholesteric film, as well as the main reflection peak there are overtone bands at the sides of the main peak. At longer wavelengths these side reflection bands become more prominent and has a significant effect on the human eyes perception (due to its spectral sensitivity curve) (fig A). The combined result is that the orange side bands are ‘amplified’ (fig B), resulting in the brain perceiving a shorter wavelength i.e. orange/red rather then red.

The most common improvement method is to add dyes to the liquid crystal. However, for an outdoor product, (our target) this causes higher sensitivity visible light leading to instability of the liquid crystal. Therefore, a filter technique, which is outside the liquid crystal layer, was sought and developed into a viable product.

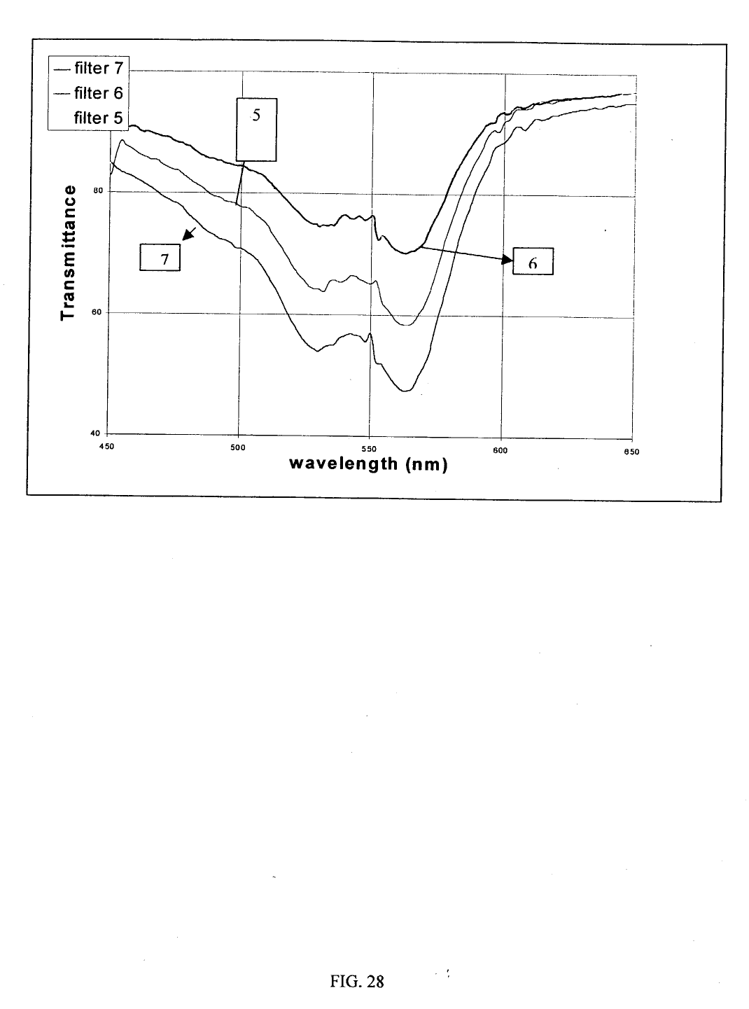

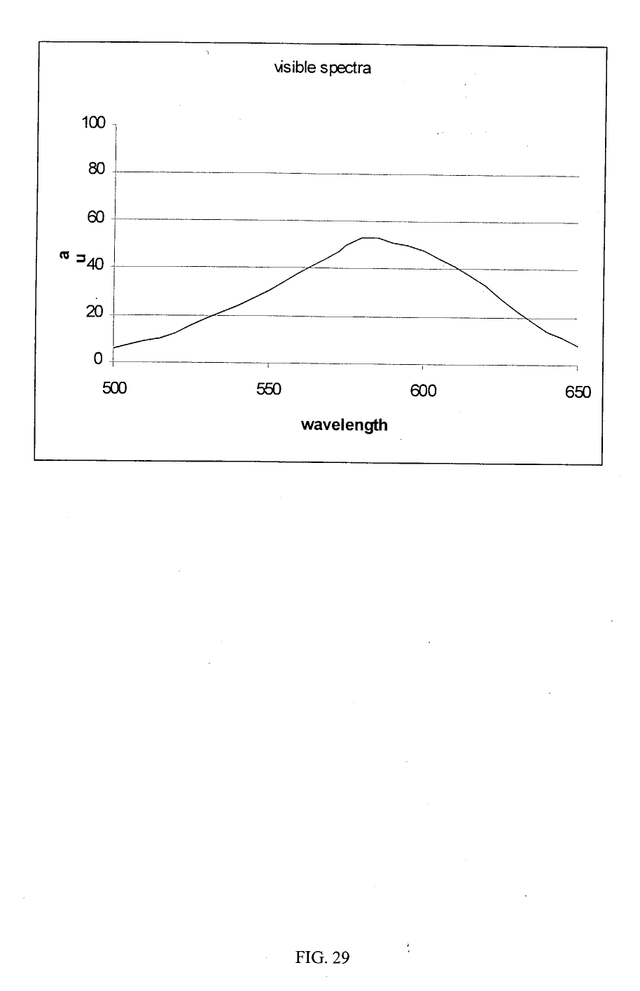

Summary—Results—Several red liquid crystal mixtures were made (FIG. 28). Filters were prepared using pigmented inks that gave a filter that could be made in different thickness' to give films that were nominally 10, 20 and 40 um thick. Purple, red and magenta pigments were used (FIG. 29). FIG. 28—Transmittance spectra of 4 different ChLC mixtures.

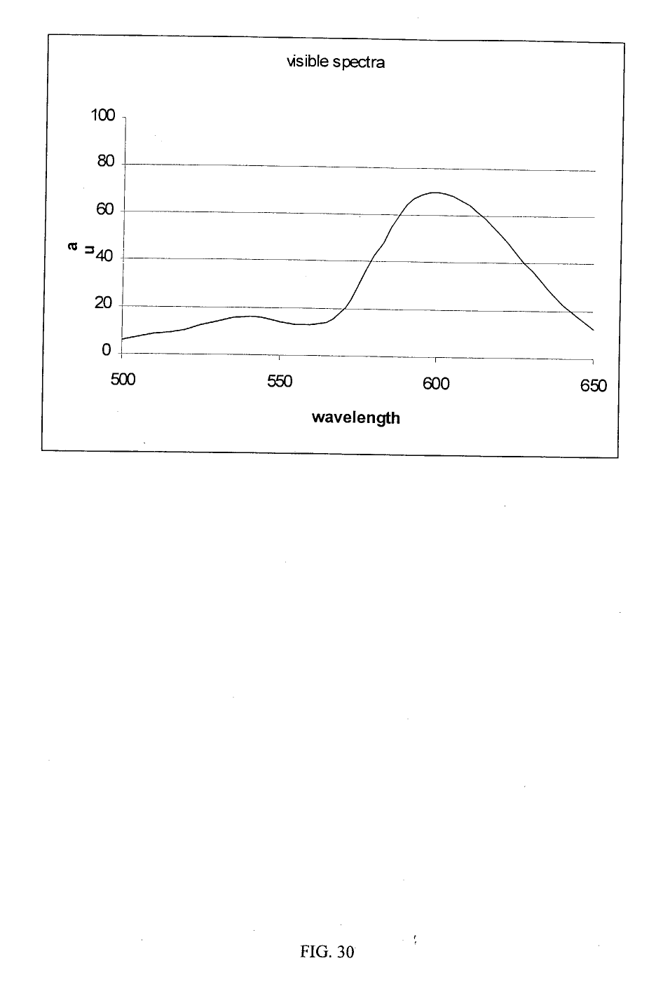

The reflectance off the test cells with a black background and with and without the addition of the filters is shown in table (below). FIG. 29 Transmittance spectra of filters 1, 2 and 4 and (FIG. 30) transmittance spectra of 3 different concentration magenta filters (5,6 and 7).

| L.C. mixture | Filter | Y | x | y |
|---|---|---|---|---|
| Mixture #1 | none | 12.96 | 0.36 | 0.34 |
| | 5 | 7.87 | 0.37 | 0.28 |
| | 6 | 8.96 | 0.36 | 0.29 |
| | 7 | 9.27 | 0.35 | 0.29 |
| | 2 | 5.84 | 0.61 | 0.32 |
| Mixture #2, 3 and 4 | various | | | |

Table (above) Reflectance from some combinations of liquid crystal mixtures with different filters.

Clearly some light is lost in the filter as seen in the reflectance (Y.) While the filter (No2) gives the best red color reflectance as defined by xy, it also reduces the reflectance (Y) more then the other filter types. Using variants of the ChLC mixtures and filters and fitting these spectra to what the eye perceives an optimum red color ChLC and filter were selected.

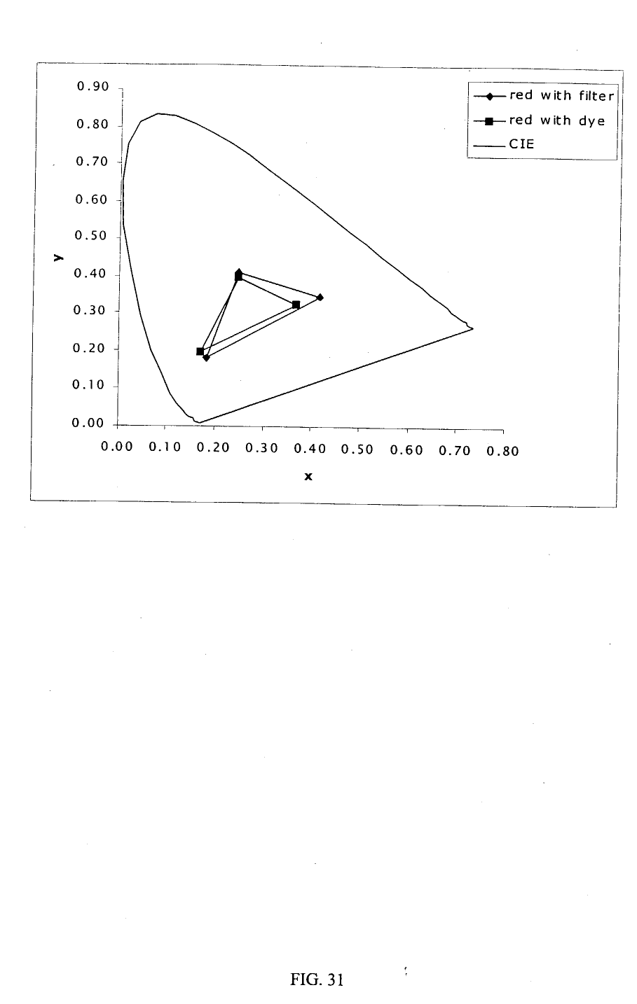

Summary—Impact—The addition of the filter, results in a changed perception of the red color (FIG. 31-32). The combination of the red ChLC and the eye's sensitivity curve is a reflected spectra centered on the orange sideband, with □max˜580 nm (FIG. 31) while with a filter this moves to 600 nm (FIG. 32). The filter has reduced the perception of the orange side band allowing for better perception of the red wavelengths.

FIG. (31-32) Showing the same liquid crystal spectra, (a) As perceived without modification to the eye sensitivity and (b) showing the enhanced perception visible spectra intensity using a filter.

The xy coordinates of a three layer stack were measured with a red layer doped with dye, and with a red filter developed here (FIG. 33). Improvement in the green and blue are also seen. FIG. 33 Comparison between color triangles using red liquid crystal mixture with dye and using red liquid crystal mixture with a red filter.

[1] While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I/We claim:

1. A Psychophysical Perception Enhancement, for use in juxtaposition to a perceptible output spectrum, and the enhancement includes:
(a) designating a target enhancement region in the spectrum and the region is defined as having at least one boundary;
(b) proximate to one of the boundaries, defining a perceptible transition region; and
(c) in the transition region, applying a filter having a spectral shape substantially inverse to normal perception for the transition region.

2. A Psychophysical Perception Enhancement according to claim 1 wherein the target enhancement region is on a visual perception spectrum.

3. A Psychophysical Perception Enhancement according to claim 2 wherein the target enhancement region is on a red side of the visual perception spectrum.

4. A Psychophysical Perception Enhancement according to claim 2 wherein the target enhancement region is on a violet side of the visual perception spectrum.

5. A Psychophysical Perception Enhancement according to claim 2 wherein the target enhancement region is on the visual perception spectrum, substantially between a red side and a violet side of the spectrum.

6. A Psychophysical Perception Enhancement according to claim 2 wherein applying a filter includes embodying said filter as a pigmented layer placed substantially parallel to the perceptible output spectrum.

7. A Psychophysical Perception Enhancement according to claim 2 wherein applying a filter includes embodying said filter as a digital signal processing circuit for modifying signals that are substantially encoding the perceptible output spectrum.

8. A Psychophysical Perception Enhancement according to claim 2 wherein applying a filter includes embodying said filter as a analog electronic circuit for modifying signals that are substantially encoding the perceptible output spectrum.

9. A Psychophysical Perception Enhancement according to claim 2 wherein applying a filter includes embodying said filter as a passive semitransparent material for modifying output from the perceptible output spectrum.

10. A Psychophysical Perception Enhancement according to claim 2 wherein the perceptible output spectrum is optically passive.

11. A Psychophysical Perception Enhancement according to claim 2 wherein the perceptible output spectrum is optically active.

12. A Psychophysical Perception Enhancement according to claim 2 wherein the perceptible output spectrum derives from a device selected from the list: a liquid crystal display, an encapsulated liquid crystal display layer, an encapsulated liquid crystal display pixel element, an electric light source, a light bulb, a cathode ray tube, a light emitting surface of a cathode ray tube, a pixel element of a light emitting surface of a cathode ray tube, an incandescent light bulb, a fluorescent light bulb, a halogen light bulb, a mercury vapor light bulb, a neon lighting tube, a light emitting diode, a plasma light source, an arc lamp.

13. A Psychophysical Perception Enhancement according to claim 2 wherein applying a filter includes embodying said filter as a coating to an optical element in front of the perceptible output spectrum.

14. A Psychophysical Perception Enhancement according to claim 2 wherein applying a filter includes embodying said filter as a doping in an optical element in front of the perceptible output spectrum.

15. A Psychophysical Perception Enhancement according to claim 9 wherein the filter is a red cholesteric mixture with a peak reflection above 600 nm.

16. A Psychophysical Perception Enhancement according to claim 9 wherein the filter is a red cholesteric mixture substantially as hereinbefore described and illustrated.

17. A Psychophysical Perception Enhancement according to claim 1 wherein the target enhancement region is on an audio perception spectrum.

18. A Psychophysical Perception Enhancement according to claim 17 wherein the target enhancement region is on a low frequency side of the audio perception spectrum.

19. A Psychophysical Perception Enhancement according to claim 17 wherein the target enhancement region is on a high frequency side of the audio perception spectrum.

20. A Psychophysical Perception Enhancement according to claim 17 wherein the target enhancement region is on the audio perception spectrum, substantially between a low frequency side and a high frequency side of the spectrum.

21. A Psychophysical Perception Enhancement according to claim 17 wherein applying a filter includes embodying said filter as a sonic-permeable layer placed substantially parallel to the perceptible output spectrum.

22. A Psychophysical Perception Enhancement according to claim 17 wherein applying a filter includes embodying said filter as a digital signal processing circuit for modifying signals that are substantially encoding the perceptible output spectrum.

23. A Psychophysical Perception Enhancement according to claim 17 wherein applying a filter includes embodying said filter as a analog electronic circuit for modifying signals that are substantially encoding the perceptible output spectrum.

24. A Psychophysical Perception Enhancement according to claim 17 wherein applying a filter includes embodying said filter as a passive semitransparent material for modifying output from the perceptible output spectrum.

25. A Psychophysical Perception Enhancement according to claim 17 wherein the perceptible output spectrum is acoustically passive.

26. A Psychophysical Perception Enhancement according to claim 17 wherein the perceptible output spectrum is acoustically active.

27. A Psychophysical Perception Enhancement according to claim 17 wherein the perceptible output spectrum derives from a device selected from the list: a microphone, a microphone of a hearing aid, a microphone of a telephone, an audio codex, a sound amplifier, a signal generator, an audio synthesizer, a vibration sensor, a solenoid pickup, a solid-state pickup, a differential sensor.

28. A Psychophysical Perception Enhancement according to claim 1 wherein defining the perceptible transition region includes allowing a sufficiently broad region for a normal perceiver to differentiate between two equivalent energy narrow regions that are respectively located at different non-intersecting spectral addresses within the transition region.

29. A Psychophysical Perception Enhancement according to claim 1 wherein applying a filter having a spectral shape substantially inverse to normal perception for the transition region includes equating normal perception with a majority of results in statistical sampling of a large population.

30. A Psychophysical Perception Enhancement according to claim 1 wherein applying a filter having a spectral shape substantially inverse to normal perception for the transition region includes equating normal perception with a majority of results in statistical sampling of a population having a predetermined perceptual impairment.

31. A Psychophysical Perception Enhancement according to claim 1 wherein applying a filter having a spectral shape substantially inverse to normal perception for the transition region includes equating normal perception with perception measurements for a predetermined individual.

32. A Psychophysical Perception Enhancement Filter compliant with the Psychophysical Perception Enhancement according to any of claims 1-31.

33. A program storage device readable by a machine, tangibly embodying a program of instructions executable by the machine to perform method steps for A Psychophysical Perception Enhancement Filter, said method steps comprising;
(a) accepting a designation of a target enhancement region in a perceptible output spectrum and the region is defined as having at least one boundary;
(b) accepting a definition of a perceptible transition region that is proximate to one of the boundaries; and
(c) in the transition region, applying a filter having a spectral shape substantially inverse to normal perception for the transition region.
